(19) United States
(12) Patent Application Publication
(10) Pub. No.: US 2014/0006342 A1
(43) Pub. Date: Jan. 2, 2014

(54) Systems for the integrated design, operation and modification of databases and associated web applications

(71) Applicants: Thomas Love, Cromwell, CT (US); Paul James, Ware, MA (US)

(72) Inventors: Thomas Love, Cromwell, CT (US); Paul James, Ware, MA (US)

(21) Appl. No.: 13/506,866

(22) Filed: Jun. 27, 2012

(51) Int. Cl. G06F 17/30

(52) U.S. Cl. 707/609; 707/E17.005

(57) ABSTRACT

The system is a database-driven web-application system that includes a task-based data-driven language that provides:
strict naming rules for objects in the system
specifically designed SQL views of database tables
a view-maintenance executable that maintains all of said SQL views and is executed after each change to the databases
software functions that implement all accesses to the databases following strict rules and audit procedures
executables to perform jobs requested by end-users or on schedules
a task system and database for centralizing all user interactions from any source
web application that translates the task database into a web-based user interface
a set of executables that use the task system to export and import relationally sound data to disconnected formats such as spreadsheets
meta-function databases that enable the addition of various functions to each row in the database on an as-needed basis

### CROSS-REFERENCE TO RELATED APPLICATIONS

This application claims the benefit of Provisional Patent Application Docket No. 61/488,596 which is incorporated by reference.

### BACKGROUND OF THE INVENTION

1. Field of the Invention

This application relates to web browsers, web server applications, databases and related software, servers and software working with database servers, email, file transfer and display, and database data import/export software and processes.

2. Description of Related Art

Complex database driven website development and maintenance is an inefficient, intellectually chaotic, expensive process that usually leads over time to products that are not maintainable and which ultimately fail financially and are abandoned. Database driven web sites consist of a minimum of three separate development languages: the web site language (for example, dot.net asp, PHP, cold fusion, java), SQL (the language of databases) and stored procedures (vendor specific languages that work with the vendor's database) and possible a fourth business layer coded in c# or java. These languages have different underlying design philosophies. In addition, due to the limitations of HTML, the web development languages tend to treat each page on a web site as a separate program, adding dramatically to the complexity of the overall product.

Commonly, in version 1 of the typical database driven web application, the various languages and database structures are tightly coupled, having been developed by a fixed team of personnel with a relatively clear set of design goals. But over time, as modifications are made and features added, the coupling between the database back end, intermediate code and the web front end can break down. Teams change, design philosophies change, the languages themselves lead to different design choices because of their underlying different natures, and the interactions between the web front end and the data back end become extraordinarily complex. Essentially, one web application becomes hundreds, and one database becomes hundreds. Eventually, the code base becomes largely a massive exception handling routine, as every feature runs under different design philosophy and the various code bases migrate away from each other.

This increasing complexity eventually leads (in year four or five) to a situation where changes to the system become extraordinarily brittle and complex, e.g. changes to add features become increasingly difficult to make. Partitioning and other scaling techniques become more difficult to incorporate. Further, usually in this time frame, the pace of technology calls for major feature improvements, which cannot be made to the now extraordinarily complex system without breaking the existing features. New features can be driven by new technologies such as cell phones or new legal requirements such as PCI and HIPAA.

Additional problems occur because many database designs incorporate procedural assumptions about the roles of users, and hard-code these roles into the system. Modifications of these systems, as new roles are discovered and existing roles are changed, become increasingly difficult.

Additional problems occur because the user interfaces make dealing with large amounts of clerical data tedious and difficult, and import export routines are simplistic, complex, not tied to the user interface and what the user is seeing and difficult for end-users to use.

Additional problems occur because scalability issues regarding the design of the database are frequently overlooked in the design stage of the project. Scalability issues later can cause major redesign problems.

Additional problems occur because different database vendors implement features in different ways, making transferring databases among databases of various vendors difficult.

Numerous attempts have been made to fix this tendency towards chaos and lack of maintainability. Various agile methodologies have been proposed. They have generally failed to address a central issue: the design philosophy of the web end of such projects is fundamentally different from the design philosophy of the database end of such projects, and the two philosophies inevitably migrate away from each other.

### BRIEF SUMMARY OF THE INVENTION

The embodiment of the system described herein has the advantages summarized in Table 1:

TABLE 1
data driven design and data driven task application model from a central
database of design elements which provides a central point of reference
for all applications developed in any language, both for web and database
development
naming and design conventions designed to improve automated design
and development, maintenance and scalability
executables (software) to automate the maintenance and improvement of
the system scalability, including automated partitioning
the ability to add global meta-functions to any table and record in the
database including a complete audit function
complete coherent export/import for disconnected data formats such as
spreadsheets based on the same centralized database of design elements,
providing a tight coupling between the user and the export/import
functions
vendor independence

The hardware used in the system includes the following: web servers, database servers, job servers, file servers, video servers and email servers.

The software used in the system consists of object naming conventions, the view system, the meta function system, and the task/application/job system and the import/export system

The object naming system names and classifies objects by their use in the system, and therefore permits the rapid and consistent development of software applications, which applications are simplified by the ability to rely on consistent object names in coding the application for object use.

The view system translates database objects automatically into views which, given consistent object naming, can be scaled, distributed across servers and rapidly coded into software applications.

The meta-function system consists of a permanent identification system for all database objects which creates a consistent system of access and use by applications and enables the rapid addition of features to the system without redesign of underlying objects.

The task system centralizes all user interface code in a data driven task system, which enables a variety of software applications including web applications and job applications to address the system in a consistent and scalable manner, independent of programming language.

The job system relies on the foregoing to automate non-user interactive tasks on a consistent basis.

The design of the system enables rapid import and export of data in a consistent manner that does not require custom code for each type of import/export.

The system enables, among other things, automated maintenance and development, code reusability, rapid addition of global features, automated security auditing, disconnected delivery and receipt of data from end users and independence from vendor specific locking, SQL statement formatting and foreign key mechanisms.

### BRIEF DESCRIPTION OF THE DRAWINGS

FIG. 1 is an overview of the hardware used in the system.

FIG. 2 is an overview of the view system.

FIG. 3 is an overview of the components of the meta function system.

FIG. 4 describes the primary table linking system.

FIG. 5 describes the components the default design of user meta functions.

FIG. 6 describes the meta function audit system.

FIG. 7 is an overview of the components of the meta function text messaging system.

FIG. 8 describes the user messaging process.

FIG. 9 is an overview of the components of video and non-video file sharing.

FIG. 10 describes the operation of the file processing server and system.

FIG. 11 describes the job executable=s operation on the file processing.

FIG. 12 describes the job executable=s operation on the file downloads.

FIG. 13 describes the video and non-video file sharing libraries.

FIG. 14 describes the calendar/event system.

FIG. 15 describes the calendar/task system.

FIG. 16 describes the address book system.

FIG. 17 describes the keyword tagging system

FIG. 18 describes the approval system.

FIG. 19 describes the video conferencing system.

FIG. 20 describes the billing system.

FIG. 21 describes the alert system.

FIG. 22 describes the language system.

FIG. 23 describes the task system.

### DETAILED DESCRIPTION OF THE INVENTION

### Overview/Hardware

The hardware expected to be used in this embodiment is illustrated by FIG. 1. The hardware system is designed to be standardized and scalable by increasing the number ofunits employed by the system.

Web servers, FIG. 1, item 1. The system uses standard web servers to present the web application user interface. The system can use any of the commonly available web servers.

Database servers, FIG. 1, item 2. The system users standard SQL servers as the data repository, and as the storage of the task system. The system can use any of the commonly available SQL servers.

Job servers, FIG. 1, item 3. The system relies on job servers both for modification and maintenance of the system and to distribute work away from the user interface to make the system more scalable. These servers and the job executable programming language can be of any commonly available type.

Email servers, FIG. 1, item 4. The system uses standard email servers to provide email and SMS messaging. The system can use any of the commonly available email servers.

Video servers, FIG. 1, item 5. The system uses standard video servers to present pre-recorded and video and streaming video. The system can use any of the commonly available video servers.

File servers, FIG. 1, item 6. The system uses standard file servers to store files and provide files to the web servers, the video servers and the email servers. The system can use any of the commonly available file servers.

File transfer servers, FIG. 1, item 7. The system uses standard file transfer servers to provide file upload/download services to the end users. The system can use any of the commonly available file transfer servers.

PCs and Smart phones, FIG. 1, item 8. The system provides services to any type of end user systems can that supports a standard web browser, including both PCs and Smart phones.

### Overview/Software Systems

Table 2 describes the overall layout of the software used in the described embodiment of the system.

TABLE 2

| Component | Description | |
|---|---|---|
| Naming | Strict naming conventions for all database objects are | |
| conventions | followed, which enables general code reuse. | |
| View system | The data system is accessed through standardized views | |
| | which are maintained by a specific job executable | |
| Meta function | The meta function system enables the addition of user | |
| system | functionality to every database object. | |
| Task system | The task system controls the operation of the web | |
| | application, the job executables and the import/export | |
| | system | |
| | job system | the job system handles all non-user |
| | | interactive tasks |
| | spreadsheet | the import/export system handles all |
| | import/export | import/export functions from and to the |
| | system | database system. |

### Naming Conventions/Overview

The system is built on strict predictability and uniformity of the existence and attributes of required elements, including mandatory fields in all tables with mandatory names, and required prefix naming rules for optional fields, and mandatory prefix rules for tables and databases. All of the systems described generally herein rely to a greater or lesser degree on mandatory naming conventions for database objects. Any field, table or database which requires programmatic, automated handling is identified as such through the use of mandatory names and prefixes. This section describes all of the naming conventions for all of the systems. Individual system descriptions contain further detail on their specific naming requirements.

Naming Conventions/Fields/Mandatory fields

Table 3 describes mandatory fields in all database tables.

TABLE 3

| | | | |
|---|---|---|---|
| 1 | s_rowId | 8 byte integer | primary identity field - provided by |
| | | | the system, incrementing integer |
| 2 | s_rowIdg | 20 byte binary | sha1 hash value of s_rowId |
| | | | concatentated with a permanent |
| | | | salt |
| 3 | s_timeStamp | time stamp | globally unique number which |
| | | | advances each time any field |
| | | | in the row is changed |
| 4 | r_rowTime | datetime | creation time of row |
| 5 | r_rowStatus | 1 byte integer | the operational status of the row |
| 6 | r_jobStatus | two byte | the job status of the row |
| | | integer | |

Mandatory fields are present in every table. They have two prefixes: r_and s_. r_prefix fields have values of which are changed by the operation of the task/web/job applications. s_prefix fields are never changed from their original values as supplied by the database engine. s_fields are not audited, r_fields are audited.

s_rowId described in Table 3, item 1. This provides a consistent globally unique identifier for the row within its table and all partitions of that table. Every row in every table in every database can be uniquely identified by this field.

This field is indexed to increase the speed of joins and searches. This field is used to enforce foreign key constraints and is the return result of all searches and text searches. This surrogate primary key field is used in every table instead of natural keys. In order to provide for vendor independence, the is an incrementing integer.

All natural key fields are based on human generated data. All human generated data contains errors. When errors are corrected or changed, the relational integrity of table relationships built on that key are destroyed. Surrogate key fields eliminate this problem.

Surrogate key fields are uniform in name and content and are needed only once in each table, and therefore enable automated development and maintenance of the database. Natural keys are not uniform in name, content or the number of fields comprising the key, and thus inhibit automated development and maintenance.

Export/import to/from spreadsheets is possible using surrogate keys. Natural key edits by end users would cause the key to change and result in the loss of relational integrity.

s_rowIdg described in Table 3, item 2. This is an SHA1 hash (concatentated with a permanent salt value). This is used when the primary key must be emitted by the system to a web browser or other external source. Rather than send the primary key s_rowId, which by its incremental, predictable nature, poses a security threat went sent outside the system, the s_rowIdg value, which has a universal one-to-one permanent relationship with s_rowId, poses no threat when emitted outside the system. This feature enables the internal use of auto-incrementing primary integer keys, while eliminating the security risk posed by such keys when in the hands of external users.

s_timeStamp described in Table 3, item 3. This contains a value which is created by the system when the row is created and thereafter changes automatically from a system wide unique value to a new system wide unique value whenever any field in the row is changed. Use of the time stamp field enables the web application to use this stamp as a substitute for locking, which dramatically increases operational speed of the database by eliminating read locks. Updates to the row include the original value of the time stamp in a where clause. If the current time stamp doesn=t match (because the row has been changed in the meantime), the update fails, and the exception is brought to the user=s attention.

r_rowTime field described in Table 3, item 4. This provides an audit mechanism and a means to reduce job processing to specific time frames. It is indexed with s_jobStatus to improve speed. This keeps the job scheduling engine from scheduling newly adopted jobs or job methods against rows that precede the date of the adoption of the new job or method, and provides a method for the job system to determine the age of a row in the context of job execution criteria.

r_rowStatus field described in Table 3, item 5. This controls the active/deleted/temporary status of the field. It has the following values: 0 means the row is currently available, 1 means the row is deleted 2 means the row is temporarily in use by the creating user through the web application or job executable but has not yet been made available to all users.

This field eliminates the need for, and resources devoted to, cascading deletes (there are no deletes in this system—only status changes). Using a status indicator for deleted records greatly improves execution speed (cascading deletes and associate index updates are avoided) and scalability.

Foreign keys are enforced by using views and the Awhere exist@SQL search clause against this field (and the parent row=s s_rowId field) provided by the view system. This eliminates reliance on vendor specific foreign key coding and speeds automated development, since view creation can be more readily automated, and maintains speed.

Status makes possible exports and edits of data through the spreadsheet system, because all rows sent outside of the system still exist in it, and can be matched to such external data pools when resubmitted to the system, regardless of their then current status.

The temporary status is used by web applications to create temporary connected record sets for end user use. This simplifies web application development. The web applications temporarily create connected records with a status of temporary, in cases where a user is adding rows in the web application but has not yet committed the rows. If the rows become committed, the status is flipped to active. This eliminates the need for web applications to manage disconnected records.

Deleted records are recoverable instantly by the end user by changing the status field value. With vendor provided functionality, deletes are not recoverable by users.

r_job Status field described in Table 3 item 6. This indicates whether the row has any jobs associated with it, and if so, whether the master job scheduler has Anoticed@the row and added it to the job system.

A value of zero means either there are no jobs associated with that table or the job scheduler has not noticed the row yet, and a non-zero value means the table has at least one job associated with it and either the job has been run or the job scheduler has noticed and added the row to the job queue. The job status field is indexed with the row time field to limit jobs to a short recent time frame, so that as job types are added they are not applied to the entire record set of rows. Multiple jobs can be handled through the use of binary/and/or.

This field enables the use of the job system, which determines which jobs apply to the row based on the value in the row and, then schedules the job in a separate job database and updates the status. This process enables multiple asynchronous job processors to operate simultaneously and removes the processing load from the main web servers, improving scalability.

Naming Conventions/Specific description/Fields/Optional fields

Table 4 describes optional fields in database tables.

TABLE 4

| | Field Name | Type | Description |
|---|---|---|---|
| 1 | p_<parent table> | 8 byte integer | foreign key field (parent field). The value in the field is |
| | @<optional | | the s_rowId value or the value in the alternative link field. |
| | alternative link | | |
| | field> | | |
| 2 | e_<fieldName> | binary | encrypted data |
| 3 | h_<fieldName> | binary | hashed data |
| 4 | i_ehm | 1 byte integer | encryption/hash method in use in that row |
| 5 | d_<fieldName> | 32 byte | a description of the data in the row for display and export |
| | | unicode | import purposes |
| 6 | l_<tableName> | 8 byte | link to lookup table. The optional tag is used to permit |
| | @<optional | character | the same lookup field to be used more than once in the |
| | tag> | | same table. |
| 7 | b_<fieldName> | 1 byte integer | boolean field |
| 8 | o_<linked table> | 8 byte integer | optionally enforced foreign key. Similar in structure to |
| | @<alternative | | the p_field. |
| | field link> | | |
| 9 | o_tableId | 2 byte integer | link from meta function table to data table |
| 10 | o_rowId | 8 byte integer | link from meta function table to data table row |
| 11 | o_fieldId | 2 byte integer | link to field in another table |

Fields that are optional but require special handling when present must have prefixes, so that the special handling can be built permanently into the various applications. All fields that require special handling have a prefix in the form of <letter>_<fieldname>.

p_<parent table>@<optional alternative link field> described in Table 4, item 1. This enables the automatic management of foreign key enforcement is through views that rely on the presence of this field. The alternative link field is optional. If no alternative link field is present, then the linking field is assumed to be s_rowId in the parent table.

This field is a field of major importance in the system. The maintenance executable constructs views that enforce relational integrity by including where exists clauses in the view that refer to the chain of p_ fields and include as a search clause of row status of 0. This feature enables views to be constructed automatically by the maintenance executable. A designer merely needs to include a p_field to impose foreign key integrity. This also provides vendor independence as no engine driven foreign key enforcement is used. In addition, the system scales better than system driven foreign key systems because there are no cascading deletes to enforce. If a row is deleted (meaning a row status of not 0) then without anything further, all child rows drop from the views.

In addition, foreign keys can be made optional where needed by the application by linking the row to row 0 in the parent table. All tables contain a row with an s_rowId of zero. All child records can be linked to this row. A parent s_rowId of zero indicates that in the table in question, parent links are to be enforced when not using row zero. When using row zero, the parent link will be always valid.

e_<fieldName> described in Table 4, item 2. This indicates that this is an encrypted field (and is stored as a binary field). Also, an encryption version field is included in the table, to permit changes in passwords and salts over time. The web application and the job processor know automatically how to process the field.

h_<fieldName> described in Table 4, item 3. This is a binary field containing a hash of the data. The associated encryption version field provides additional information regarding the version of the hash method. The web application and the job processor know automatically how to process the field.

i_ehm described in Table 4, item 4. This indicates the encryption/hash version used in the row. The web application and the job processor contain the reusable code necessary to process the field. This permits encryption salts and passwords to be changed periodically.

d_<fieldName> in Table 4, item 5. This is used in web user displays and in exported data in combination with the primary key field to provide the user with a means to maintain relational integrity in spreadsheets. The d_indicates to the applications that this field can be used for these purposes. This facilitates automation of user interfaces.

l_<tableName>@<optional tag> in Table 4, item 6. This refers to a selection list table, which are maintained in separate tables with a primary identity field comprised of a short string field, and child table with two letter language designations and translated versions of the item in the selection list. Links to lookup tables use the short-string identity field. The optional tag enables the use of the same lookup more than once in the same table for different purposes.

Lookup fields and tables are built on a globally predictable structure and therefore are readily programmable. Language translation tasks are centralized in lookup tables only, making translation orderly and centralized.

b_<fieldName> field described in Table 4, item 7. This notifies the applications that this is to be treated as a yes/no true/false field, further enabling automation.

o_<linked table>@<alternative field link> field described in Table 4, item 8. This enables linking one table to another in a non-foreign key manner. The prefix o_indicates that the field in question is such a link, and the optional @<alternative field link> provides flexibility in selecting the linking field in the other table (the default is srowId). This prefix assists in automating application development through the task system by highlighting these fields for special processing and providing self-referential documentation.

o_tableId field described in Table 4, item 9. This is used by meta-function tables to indicate to which other table the row in the meta-function table is linked. The value in this field is the permanent unique value assigned to the table in question by the maintenance executable. As described below, this field supports the meta-functions. This also supports the audit function by indicating in the audit tables which table was changed.

o_rowId field described in Table 4, item 10. This is a link to the s_rowid of the row to which the meta function is linked. As described below, this field supports the meta-functions. This also supports the audit function by indicating in the audit tables which row was changed.

o_fieldId field described in Table 4, item 11. This is the permanent unique value assigned to the field in question by the maintenance executable. This is used by the audit function to track changes to the field.

### Naming Conventions/Tables

Table 5 describes the naming conventions for tables.

TABLE 5

| | Name | Description |
|---|---|---|
| 1 | <parent>$<child> | the table is a vertical partition of the |
| | | parent table |
| 2 | <parent>#<highest | the table is a horizontal partition of the |
| | s_rowId> | parent table, containing the highest |
| | | s_rowId indicated in the name |
| 3 | <table>_<table> | a many to many link table between the |
| | | two named tables |
| 4 | k_<meta function table> | this is a link table between a meta |
| | | function table and the other tables in the |
| | | system |
| 5 | l_<table> | this is a lookup table |

Table names must be unique across all databases on all SQL servers. Unique system wide table names, combined with a central view database (described below), enable the complete disconnection between the physical structure of the database files and servers and the applications. The single view database contains views of all tables, and is automatically maintained by the maintenance executable. The applications have a single connection string to a single database (the view database) that never changes, regardless of changes to the physical database files. This completely separates the physical layout among database servers from the applications. All table names start with the database prefix and a shortened (3 or 4 character version of the database=s name) to ensure table name uniqueness across all databases.

parent>$<child> described in Table 5, item 1. This indicates that this is a vertical partition table of the indicated parent table. Fields that have a one to one relationship with other fields in a table may nevertheless be split off into their own tables. All such table names have required structures: <parent tablename>$<tablename>. All child tables include the foreign key field p_<tablename> to link to the associated parent row.

Vertical partitioning improves scalability and documented logic. Scalability is improved by separating high transaction volume fields from low transaction volume fields, improving access speed to the low transaction volume fields and reducing backup size of the low transaction tables. Documented logic is improved by grouping associated fields in coherent groupings in tables. This improves the self-documented organization of the system. This also makes future development easier (by adding additional vertical portions as development needs require).

<parent>#<highest s_rowId> described in Table 5, item 2. This indicates that the table is a horizontal partition containing rows through the highest row id indicated in the name. Tables are horizontally partitioned in a very quick procedure that consists of (a) closing the table to users, (b) renaming the table as indicated, (c) creating a new empty duplicate table that starts on the next, unused row id and which is named the original name and (d) running the maintenance executable to update the views to include the newly partitioned table. This method of horizontal partition is very fast to implement and vendor independent. It is scalable and in combination with the view system it is invisible to applications.

<table>_<table> described in Table 5, item 3. This is a many to many link table. This is primarily an application development documentation technique. The table contains the two relevant p_fields.

k_<meta function table> described in Table 5, item 4. This indicates that this table is a meta link table between a meta function table and the linked tables in the rest of the database. This enables the meta functions below and serves as an application development documentation technique.

l_<table> described in Table 5, item 5. This indicates that this is a selection list table. Selection lists are maintained in separate tables with a primary identity field comprised of a short string field, and child table with two letter language designations and denormalized translated versions of the item in a series of columns, one column per language. Links to lookup tables use the short-string identity field. The optional tag enables the use of the same lookup more than once in the same table for different purposes. All lookups, regardless of language, are handled in the same manner, using the same code. Additional languages can be added merely by adding a column to the lookup tables. Both features improve the automated development of applications.

### Naming Conventions/Databases

Table 6 describes the naming conventions for databases.

TABLE 6

| | Name | Description |
|---|---|---|
| 1 | u_<n ame> | user |
| 2 | s_<name> | system |
| 3 | l_<name> | lookup data |
| 4 | t_<name> | temporary |
| 5 | m_<name> | meta function data |
| 6 | <name>#<sequence number> | horizontal partition |

Database names have standardized prefixes that provide self-documentation of the purpose of the database. Database names are also used to provide the base component of table names to provide self-documentation and a source of uniqueness for names. All databases have a single letter followed by an underscore followed by a unique name (unique per server). The following describes the detail rules for naming databases.

u_<name> described in Table 6, item 1. These are user data databases. User changeable data is stored in these databases. These databases are backed up, and all changes are audited.

s_<name> described in Table 6, item 2. These are system databases. They hold non-user changeable system data. Examples include view databases (s_view and s_zview), the system catalog database (s_dbinfo), the user task database (s_task), and the audit database (s_audit).

l_<name> described in Table 6, item 3. These are databases that contain lookup tables only. The databases a read only for speed and do not need backups (since the data is static).

t_<name> described in Table 6, item 4. These databases are temp databases. They contain data that has only temporary value (spread sheet export tables, server status tables, job request tables). They are deleted and replaced frequently because they contain large numbers of daily transactions, and deleted and recreating increases index speed.

m_<name> described in Table 6, item 5. These databases contain meta tables that support meta functionality (that is, tables the data of which is associated with tables elsewhere in the system (customarily u_database tables). There is usually one database per meta-function: files, video, email/chat/forum, addresses, calendars, tags, etc.

<name>#<sequence number> described in Table 6, item 6. This indicates that the database contains horizontally partitioned tables (using the name of the original database).

### View System

The view system controls all access to the databases. The view system provides a single, uniform point of access for web applications, job executables and the import/export system. The view system controls locking, foreign key enforcement and deletions. The view system supports scaling of databases by using views to cover horizontally scaled tables and databases. FIG. 2 is a graphical overview of the view system.

SQL server, FIG. 2, item 1. The system relies on the primary SQL server, both as for access to its databases and for its connections to scaled secondary SQL servers.

Operational database, FIG. 2, item 2. This represents the operational database upon which the view system herein described is imposed. This can be any database which conforms with the appliable rules as herein set forth.

SQL View database, FIG. 2, item 3. The view database is a separate database that contains four components: t views, h views, z views, the horizontal scaling table and the table catalog.

t view, FIG. 2, item 4. The t view is named t_<tablename> and is identical to the named table. There is one t_<tablename> view for every non-vendor required table in the system. There are no locking hints with t views. T views are used only for SQL inserts and SQL updates.

h view, FIG. 2, item 5. The h view combines all horizontally scaled tables together into a single view with each base table (base table meaning the table that is not a horizontal partition of another table) using union statements. Horizontal partitions, as noted above, are identified by name as <tablename>#0000 where 0000 is the primary id of the highest numbered row in the view. H views are used only to construct Z views and are not accessed by applications. H views contain the no lock hint, eliminating locking and greatly increasing scalability.

z view, FIG. 2, item 6. Z views enforce relational integrity. There is one z view for each h view. Using the predictable parent link fields (p_) and SQL where exist clauses included in the where clause the row status fields of the parent tables, and links through the entire chain of parent tables, z views show only those rows that have do not have a deleted or temp status at any level in the parent-child chain, that is, only rows through the entire chain of parent/children rows with a status of 0. Z views are used for SQL selects.

Horizontal scaling tables, FIG. 2, item 7. The horizontal scaling is comprised of a plink field to the table info table, a field containing the name of the horizontal scale table, a field containing the lowest s_rowID in that table, and a field containing the highest s_rowID in that table. This table enables the web application and job executables to determine with a single SQL statement the current table containing a given s_rowID, and into which table new rows should be inserted.

View maintenance executable, FIG. 2, item 8. The view maintenance executable is an executable which maintains the view system after a change is made to the database.

Table 7 describes the execution steps of the view maintenance executable.

TABLE 7

| Step | Description |
|---|---|
| 1 | The view maintenance executable creates a temporary in memory |
| | inventory of all tables and fields in all connected databases |
| | using the functions provided by the database vendor. |
| 2 | The view maintenance executable updates the horizontal |
| | scaling table for any new base tables, any deleted base tables and |
| | any new highest numbered horizontal scale tables. |
| 4 | The view maintenance executable creates a t view for all |
| | tables. |
| 5 | The view maintenance executable creates an h view for each base |
| | table. |
| 6 | The view maintenance executable creates a z view for each base |
| | tables. |

The view maintenance executable automates numerous steps in the database development/maintenance process that are otherwise required to be done laboriously by hand. It maintains all views, all foreign key relationships, and all partitions. It enables extremely rapid database/application development and modification. It is run each time changes are made to the underlying tables and updates the views, even for large database installations, in seconds. It enables rapid partitioning and database server distribution and re-configuration.

Particular note should be made of the horizontal partitioning process. Partitioned tables are created by renaming the current base table to <tablename>#<highest s_rowId>, creating a new empty table with the surrogate key appropriately incremented, and adding the table to the related h view through a union statement (executed by the view maintenance executable). Naming examples are <table name>#1234567.

This enables an extremely fast system of creating horizontal partitions, and enables the scalability benefits of horizontal scaling to be provided to applications without changing a single line of code (because the views include the horizontal partitions automatically). This method is vendor independent, and fits directly into the view system. The incrementally named table can be stored in any other database, on any drive system, on any linked server, improving scalability. The system is simple, and can be readily automated (take db offline, rename, create new blank db using the table construction executable with a properly incremented primary key, run the view maintenance executable). Updates can be made directly to the t view representing the partitioned table rather than through the z view, because the application can readily determine which partitioned table contains the row by simple examination of the partitioned table names. This technique improves speed further.

Application functions automatically identify the unpartitioned table for updates, by simply examining the names of the partitioned tables. The benefit of horizontal partitioning is execution speed and backup time. Inserts take far less time if the table involved is small. Tables can be spread among federated SQL servers. In transaction tables, the partitioned tables can be made read only, improving their speed by eliminating locking overhead. Backups of partitioned tables need only be performed once if they are made read only.

Table construction executable, FIG. 2, item 9. The table construction executable is an executable to regularize the creation and modification of database tables in accordance with these rules. The executable uses structure data from table construction spreadsheets (described following) and creates the database tables.

Table 8 describes the execution steps of the table construction executable.

TABLE 8

| Step | Description |
|---|---|
| 1 | The table construction executable creates the specified database |
| | if it does not exist, using the SQL engine vendor = s standard |
| | commands |
| 2 | The table construction executable drops and recreates every |
| | indicated table, following the naming conventions and including |
| | required fields, as indicated in the table construction spreadsheets |
| | described below. |
| 3 | The table construction executable drops any additional tables |
| | in the database that are not specified in the table construction |
| | spreadsheet. |
| 4 | The table construction executable inserts the parent zero row in |
| | every table |
| 5 | The table construction executable inserts any data specified in the |
| | table construction spreadsheet. |

Table construction spreadsheet, FIG. 2, item 10. The table construction spreadsheet design is a specially formatted spreadsheets used by system designers, creates databases and tables that conform strictly to the naming conventions. The contents of the spreadsheet are executed against the SQL database by the table construction executable.

Table 9 describes the organization of the table construction spreadsheet

TABLE 9

| | Sheet | Column | Description |
|---|---|---|---|
| 1 | database | table name | the names of the tables in the |
| | | | database |
| | | description | the description of each table in |
| | | | the database |
| | | s_rowId | the starting s_rowId of each table |
| | | | in the database |
| 2 | <table>-structure | fieldName | the name of each field in the table |
| | | sqlType | the data type of the field |
| | | sqlSize | the size of the field |
| | | indexYN | whether or not to index, 0 or 1, or |
| | | | uniquely index 2, |
| | | | or text index −1 |
| | | defaultValue | the default value |
| | | description | the description of the field |
| 3 | <table>-data | s_rowID | the s_rowId of the row to be |
| | | | inserted |

The spreadsheet file name serves as the name of the database

Table 9, item 1. The first sheet lists the tables to be created in the database, their descriptions and their starting s_rowIds (note that they always have a row with an s_rowId of zero, so this field indicates where the next row=s numbering should start

Table 9, item 2. This sheet is named <tableName>-structure, and contains the parameters for the table, i.e. field name, SQL data type, SQL field size, whether to index the field, the field=s default value if indexed, the field=s description—note that this sheet is repeated for each table to be created

Table 9, item 3—This sheet contains the data, if any, to be inserted into the table—note that this sheet can be repeated for each table to be created.

No deletion—foreign key enforcement, FIG. 2 item 11. No records are deleted from the system. Instead, records that have a status of deleted are marked with a r_rowStatus of 1. This has the advantage of speed over vendor=s deletion routines, as the r_rowStatus field is not indexed and therefore deletions impose almost no overhead on the system. However, this means that vendor provided foreign key enforcement mechanism=s do not work (since no parent row is Adeleted@, no child row is ever deleted either). This does increase the speed of the system but requires a replacement of vendor foreign key mechanisms.

Foreign key relationships are enforced by the standardized z views, not by the database vendor=s foreign key engine. The standardized views rely on the self-documenting standardized field names for parent fields (p_<parent table> and primary key fields (s_rowId) and Awhere exists@search clauses relying on the standardized status record (r_rowStatus), to enforce foreign key relationships.

Parent zero row, FIG. 2, item 12. In addition, each table has an unused row with an s_row id of 0, and the default value of all p_fields is 0. This creates the ability to have optionally enforced self-referencing parent relationships (that is, one row in a table can be a parent of another row in the same table and parent child relationships can be added and removed at will, simply by either using parent row zero (which means no parent) or a parent row s_rowID of a value other than zero. An example of this mechanism is a hierarchical set of records in a single table, where the parent of any record can be change programmatically or removed entirely by referring to the default parent row of 0.

The lookup tables rely on the parent zero feature to provide hiearachical lookups within a single table. The main lookup rows all have a parent row of zero. If there is a hierarchy of lookups, then the main rows will have children rows in them where the parent zero field value is the row ID of the parent. The web application and the job application will automatically navigate the user through the hierarchy by detecting the existence of these child rows.

### Meta Function System

Meta-functions are database supported functions and features made available to users though the web application and the tasks system that can be applied to any other table in the system. Meta-functions are Aattached@programmatically to any table and row in the system by linking the meta-function=s tables that store the meta-function data to an associated link table that links to the other tables in the databases using the permanent table IDS and row IDS from the table catalog. The presentation of meta-functions is handled by the web application as directed by the task system discussed elsewhere herein. Meta functions are attached to single rows, so they are usually presented to the user when editing a single row as part of a Atool bar@. Code necessary to display them in the web application is standardized, because of the underlying uniformity of the system.

The purpose of this system is to make all meta-functions Ain-context@, that is, not simply messaging between users, but messaging between users in the context of some other jointly-accessible element of the system. Meta-functions are typically web 2.0 style collaboration functions, but they can be any Ain-context@ functionality.

Meta functions can be linked to each other. For example, an address book entry and a file entry can be linked to an event item.

FIG. 3 is an overview of the components of the meta function system.

### Meta Function System/SQL Server

SQL server, FIG. 3 item 1. The system requires at least one SQL server. This includes an operational database, in which the operational data for the system is stored.

### Meta Function System/Table Catalog

Table catalog, FIG. 3 item 2. The entire meta-function system depends on a catalog of tables and field that are assigned permanent system wide unique identifiers, and the use of the surrogate primary key field s_rowid and the row status field r_rowStatus. This system is called the table catalog.

Table 10 describes the field design of the table info table portion of the table catalog.

TABLE 10

| Field Name | Purpose |
|---|---|
| s_rowId | unique and permanent row identifier |
| r_rowStatus | active, deleted, temp status |
| server name | the name of the connected server where the table is |
| | located |
| database name | the name of the database containing the table |
| English name | plain language version of the field name, to be used in |
| | the language system described below |

Table 11 describes the field design of the field info table portion of the table catalog.

TABLE 11

| Field Name | Purpose |
|---|---|
| r_rowStatus | active, deleted, temp status |
| p_table | foreign key link to s_rowid of master table |
| field name | the name of the field |
| type | SQL type - used by the web application and the job |
| | executable |
| max_length | SQL field information - used by the web application and the |
| | job executable |
| precision | SQL field information - used by the web application and the |
| | job executable |
| scale | SQL field information - used by the web application and the |
| | job executable |
| is_nullable | SQL field information - used by the web application and the |
| | job executable |
| is_computed | SQL field information - used by the web application and the |
| | job executable |
| is_identity | SQL field information - used by the web application and the |
| | job executable |
| b_indexed | SQL field information - used by the web application and the |
| | job executable |
| b_unique | SQL field information - used by the web application and the |
| | job executable |
| default value | SQL field information - used by the web application and the |
| | job executable |
| name | plain language version of the field name, to be used in the |
| localization | language system described below |
| columns | |

Every table in every database is required to have a system wide unique name (see Naming conventions). These names are unique across the entire system, not merely by database. Views for these tables are stored in the view system database and are maintained by the view maintenance executable. The view maintenance executable also creates and maintains the two tables constituting the table catalog that track tables and fields system wide. In the table info table, each table in every database is assigned a permanent unique numeric id (s_rowId). In the field info table, each field is assigned a permanent unique numeric id (s_rowId) and linked to its parent table in the table info table. If a table or field is deleted, its status in these tables is changed to deleted (using r_rowStatus), thereby preserving its unique id. If the table or field is later re-created, the original id is re-instituted. The two tables are maintained by the view maintenance executable, which constructs and maintains them by selecting the system=s database structure from the system=s database engine, and then matching the current structure against the structure recorded in the two tables, and making adjustments as needed. The tables also contain columns for language translation to provide localize audit reports. The field table also contains SQL catalog information, to reduce application overhead in obtaining this information.

The table field info system is the basis for system wide auditing and system wide meta-functions, as well as the web application=s and job executables=use of the field catalog information. The maintenance of the system is automated by the view executable, so changes made elsewhere in the system are reflected automatically in the table catalog.

### Meta Function System/View Maintenance Executable

View maintenance executable, FIG. 3, item 3. As noted above, the table catalog tables are stored in the view database and are maintained by the view maintenance executable.

Table 12 describes the process executed by the view maintenance executable in updating the table catalog.

TABLE 12

| | |
|---|---|
| 1 | The view maintenance executable changes the r_rowStatus field to |
| | deleted for all rows in the table info table and the field info table. |
| | Note, the rows are not deleted, merely marked as deleted, which |
| | preserves their unique id. |
| 2 | The view maintenance executable creates an in memory inventory of |
| | all connected database servers using information provided by the |
| | local database server. |
| 3 | The view maintenance executable build a list of all tables on all |
| | servers (limiting the table list to tables in the prefixed databases, to |
| | avoid system databases) by interrogating each connected database |
| | server |
| 4 | The view maintenance executable changes the table info table row |
| | status back to active from deleted in the table database, or add it if |
| | it doesn = t exist |
| 6 | The view maintenance executable get a list of all fields of that table |
| | and related catalog |
| 7 | The view maintenance executable change each field = s field info |
| | table row status back to active from deleted in the field database, or |
| | add it if it doesn = t exist |
| 8 | The view maintenance executable update all of the associated fields |
| | in the field database |

### Meta Function System/Web Application—Task System

Web application/Task system, FIG. 3, item 4. The system relies on the web application using the task system (described below) to provide the user interface to for the meta functions to the end user.

### Meta Function System/Primary Table Linking System

Primary table linking system, FIG. 3, item 5. The primary table linking system uses the table catalog to create links between any table and any other table. This system enables the rapid introduction of new features, and the linking of these features to users. FIG. 4 describes the primary table linking system.

SQL server, FIG. 4, item 1. This is the SQL server described in FIG. 3, item 1.

Primary table, FIG. 4, item 2. This is an operational table into which primary data is being stored.

Table Catalog, FIG. 4, item 3. This is the table catalog described in FIG. 3, item 2. The table catalog provides the table IDs used in the linking table.

User table, FIG. 4, item 4. The user table provides the user IDs used to identify the users.

Meta function table, FIG. 4, item 5. This table contains the data supporting a meta function. This can be, in other embodiments, any other table of any type in the database.

Linking table, FIG. 4, item 6. This table contains up to three links, one to the primary table, one to the user table and one to the meta function table. The links are in the form of <table id> (from the table catalog)<s_rowId>, each for the table in question. In some embodiments the main linking table would itself be linked to one or more of the other three tables (primary, user, meta function) by many to many linking tables.

### Meta Function System/User Meta Function Tables

User meta function tables, FIG. 3, item 6. User meta function tables follow a generally consistent layout, enabling rapid implementation of meta functions using reusable code. FIG. 5 describes the components the default design of multiple connection meta functions. This general structure enables numerous meta functions to be added to the system using the same (or nearly the same) table structure for each meta function.

SQL Server, FIG. 5, item 1. This is the SQL server described in FIG. 3, item 1.

Primary table, FIG. 5, item 2. The primary table is the data supporting the user function to which the meta function is attached. This can be any table in the system, as determined by the web application and the job executables.

User table, FIG. 5, item 3. The user table is the source of identification of users using the meta function.

Meta function master table, FIG. 5, item 4. This is the parent table of meta function, and organizes the meta function data into a thread (where necessary) or holds the data (where not organized as a thread) and provides the mechanism for linking the meta function to the primary data table and the user table. This table includes title and description fields and records the creator user (the creator user can delete the record).

Meta function data table, FIG. 5, item 5. This table contains the data constituting or referring to the meta function (e.g., message text), and is linked as a child record to the meta function master table. As these rows may be created by others than the creator of the meta function master table row, these rows also record the creator user (who can delete the record). In instances where a thread style construction is not necessary, this table would be part of the meta function master table.

Meta function primary link table, FIG. 5, item 6. This table links the meta function master table row to the primary data table row using the table catalog system. This table also records whether all users of the primary data table can see the meta function master record or only selected users can. This is linked as a child to the meta function master table. It also records the creator user (who can delete the record).

Meta function user link table, FIG. 5, item 7. The user link table links meta function primary link table to the user table lists the users who have access to the meta function data. The user link table also indicates whether the user is read-only or read-write (meaning view only or the user can add rows to the meta function data table). It also records the creator user (who can delete the record).

Meta function web application/task system, FIG. 5, item 8. When a user is viewing a single primary table record, the web application determines from the task system whether the toolbar should display the meta function, and whether the user is view only or can create meta function records. If the user is view only, then the web application displays a list of existing meta function master table records. If the user can create records, then the web application enables the user to attach existing meta function master records that the user has already created or to create a new meta function master record, and indicate wether all primary table users should be automatically associated with the meta function record or whether the creator user will have to authorize each user individually. The web application then creates the master meta function record, the meta function primary link record, and at least one user link record to the creating user, and more user link records if indicated.

Meta function data link table, FIG. 5, item 9. This table links the meta function data table row to the user table. This table is used in those meta functions where individual data items constitute the sum of the meta function, or may have links to other tables. This table also records whether all users of the primary data table can see the meta function master record or only selected users can. This is linked as a child to the meta function master table. It also records the creator user (who can delete the record)

When user links are added to and removed from the primary data table records, the web application asks the user whether such changes should be applied to all user links to meta functions link to the primary table record.

### Meta Function System/User Meta Functions

User meta functions, FIG. 3, item 7. User meta functions are delivered to the user through a Atool bar@ on the user=s web interface. This tool bar customarily appears when the user has selected a single primary table row for viewing/edit. Table 13 is a description of typical user meta functions. Each function is further described following Table 13.

### Meta Function System/Job System

Job system, FIG. 3, item 8. The job system is used primarily to reduce the workload of the web application by handling non-user interaction tasks and to maintain the consistency of user links to meta functions. It also handles SQL tasks such as backups, and handles file transfers among servers. It relies on the standardized per record fields of r_rowTime and r_jobStatus for processing rows.

### Meta Function System/Standardized SQL Functions

Standardized SQL functions, FIG. 3, item 9. Standardized SQL functions (described in detail) below) are used by the web application and job executable to maintain the meta-function audit system and the consistent use of the view system.

### Meta Function System/Email Server

Email server, FIG. 3, item 10. Emails sent to one or a few recipients are sent directly by the job executable using the SMTP functionality of the email server. Emails sent to a large number of users are themselves emailed to an email account for list processing. The job executable on the email server polls this account, and when an email is received, the job executable creates a temporary list for the list server function of the email server, and then sends an email to the list server. This is especially useful in sending SMS messages to large numbers of users to notify them, for example, of an emergency.

Table 13 is a description of typical user meta functions. Each of the functions are described in greater detail following.

TABLE 13

| | |
|---|---|
| Meta function | Description |

| | | |
|---|---|---|
| 1 | audit | The audit system keeps track of every change made to data tables by the users. |
| 2 | text messaging | Text messaging is handled in a unified fashion throughout the system, and |
| | | includes email, discussion and SMS. |

| | | | |
|---|---|---|---|
| 3 | video and non- | file | This is the set of related tables which enable video and non- |
| | video file | management | video file sharing throughout the system. |
| | sharing | system | |
| 4 | | libraries | Video and non-video files can be organized into libraries using |
| | | | the table catalog system. |

| | | |
|---|---|---|
| 5 | Calendar | Calendar events can be attached to any record in the database. FIG. 14 is an |
| | Events | overview of the calendar system. |
| 6 | Calendar Tasks | The calendar task system is a full hierarchical task system that can be attached to |
| | | any record in the database. |
| 7 | Address book | Contact information can be attached to any record in the database. FIG. 16 is a |
| | | description of the address book system. |
| 8 | Keyword tags | The keyword tagging system enables keyword tagging of any primary record, and |
| | | the ability to search records by keyword tag. |
| 9 | Approvals | The approval system enables users to approve the state of a record. This is |
| | | useful in billing and transaction oriented systems. |
| 10 | Video | The system manages video conferencing. |
| | Conferencing | |
| 11 | Billing | Credit card/paypal style payments can be attached to records for access. |
| 12 | User alert | Alert events applicable to the user are stored in the users record and displayed |
| | system | to the user when online |
| 13 | Language | The language system translates user text to any number of different languages. |
| | system | FIG. 22 describes the language system. |

Meta Function System/User Examples/Audit

Audit Table 13, item 1. The audit system is presented to the user in connection with each row in a primary table, and enables a full audit of changes to that row. FIG. 6 is a description of the meta function audit system.

SQL Server, FIG. 6, item 1. This is the SQL server described in FIG. 3 item 1. A SQL server is necessary to host the database.

Primary data tables, FIG. 6, item 2. Primary data tables (all of which are identified by a prefix as noted previously) except for system tables are audited. System tables are not audited because changes to those tables are made by the system, not end users, and because end users don=t have access to system tables (and therefore no ability to review audits of them).

Table catalog, FIG. 6, item 3. This is the table catalog described in FIG. 3, item 2. The table catalog system is the source of table IDs and field IDs.

Web application, standardized SQL, FIG. 6 item 4. The use of the unique id associated with each table and each field in the view table catalog enables the complete audit of every insert, update and deletion. The audit system relies on system-wide standardized SQL functions used by the web application and the job system to address all SQL functions in exactly the same manner. These functions handle all inserts, selects, updates and deletes (which are in fact updates) and compare the updated date to the previous data and update the audit tables accordingly.

Table audit table, FIG. 6, item 5. Audit consists of two tables: a table audit table and a field audit table. The table audit table records the user, the table, the row (s_rowID) and the time that a change was made to a table. The table catalog table id (s_tableId) is used to identify the table.

Table 14 describes the field design of the table audit table.

TABLE 14

| Field Name | Purpose |
|---|---|
| user id | the s_rowID of the user = s user record |
| table ID | the s_rowID of the table in the table catalog |
| action | indicates whether the audit record represents a new record |
| | (insert), a view of the record (select) changed record |
| | (update) or a deleted record (update of the delete status |
| | field) |
| date-time | the date-time of this record (and thus the change) |

Field audit table, FIG. 6, item 6. The field audit table includes a link to the table audit row id and records the field id and the final state of the data at that time. Binary data is converted to hexadecimal strings. The data is added by the standardized SQL functions automatically as part of their operations each time a field is changed.

Table 15 describes the field design of the field audit table.

TABLE 15

| Field Name | Purpose |
|---|---|
| p_table | foreign key link to the parent record in the audit table |
| data | the new (changed to) data in text form, or in the case of |
| | binary data, in hexadecimal. |

When a row is initially inserted, the standard SQL functions create a record in the table audit table only. In order to conserve resources, the individual field values are not duplicated in the audit field table, as the original values are still present in the source record. When a field is later changed, a record for the change is created in both the table audit table and the field audit table for the change (or if more than one field is changed, changes which are reflected by multiple child rows in the field audit table). In addition, in cases of changes, a row is also entered in the field audit table and linked to the original insert row in the table audit table, which row records the original value of the field. This is done to prevent the loss of an audit record of the original state of the field. This system economizes system resources (i.e., not recording the original value until the original value is changed). If a row is deleted, then an entry in the table audit table is added for the deleted row but no values are recorded in the field audit table as the values are still present in the deleted row. As no rows are physically deleted in this system, the user can review all deleted rows to which the user has access through a menu choice provided by the web application, and if need be, undelete them. When a record is selected, the system inserts a select (view) record which tracks which user viewed the record. This detailed, universal audit system enables automatic compliance with HIPAA and similar laws.

The audit function is presented by the web application to the user on a tool bar whenever the user is viewing a single record. All changes to that record can be displayed. This system creates a universal standardized audit system that works without re-coding regardless of changes to the system. This provides required compliance with HIPAA, PCI and other security standards. The audit function is universal and automatic, and made so by the procedures and techniques set out herein.

### Meta Function System/User Examples/Text Messaging Design

Text messaging Table 13, item 2. Text messaging is handled in a unified fashion throughout the system. Text messaging is handled, in each instance, as a threaded discussion, even if the thread consists of a single message. Discussions can be attached to one or two primary data tables (two are used to link discussions directly between users by linking their user records). Text messages can, in addition, be delivered outside the system immediately by email or SMS. FIG. 7 is an overview of the components of the meta function text messaging. FIG. 8 describes the user messaging process.

SQL Server, FIG. 7, item 1. This is the SQL server described in FIG. 3, item 1. The meta function requires a SQL server.

Message thread table, FIG. 7, item 2. This is the meta function master table described in FIG. 5. Messages are organized into threads using this record as the parent of the individual thread members.

Message table, FIG. 7, item 3. This is the meta function data table described in FIG. 5, item 5. This table records the content of the message and uses the master message table as the organizing parent.

Primary link table, FIG. 7, item 4. This is the meta function primary link table described in FIG. 5, item 6. This tables links threads to primary tables to which the messages are associated.

User link table, FIG. 7, item 5. This is the meta function user link table described in FIG. 5, item 7. This table includes authority status (read-only, read-write) and records read status (i.e., the highest numbered message in the thread that the user has read). The users that can be in this table are selected from the users who are linked to the primary table (making the communication Ain-context@).

Web application, FIG. 7, item 6. This is the web application described in FIG. 5, item 8. Specifically in this application, the web application asks whether new messages should be delivered by email and SMS.

Job executable, FIG. 7, item 7. The job executable carries out two tasks.
first, the job executable executes external deliveries of email and SMS,
second, the job executable executes alerts (described below).

Job table, FIG. 7, item 8. This is a link to the message record. When a sending user requests immediate delivery by email or SMS, the web application creates this record in the job system. The job executable then sends the message through the email server, using the user records to determine email addresses and SMS addresses. This improves efficiency by removing workload from the web application. The job table is updated daily by a separate job for those user messages related to users which requested daily delivery.

Email server, FIG. 7, item 9. This is used by the job executable to deliver email and SMS messages.

### Meta Function System/User Examples/Text Messaging Process

SQL Server, FIG. 8, item 1. This is the SQL server described in FIG. 3, item 1. This process requires a SQL server.

Web application, FIG. 8, item 2. The web application interacts with the user and the system to create the message.

Primary table, FIG. 8, item 3. The user selects a primary table row to view or edit. The web application displays the tool bar in the context of this record. The user either creates a new message thread in this context, or selects an existing thread.

Message, FIG. 8, item 4. The user enters the message into the web application, and optionally attaches file and library links from the file system and indicates whether the message should in addition be delivered by email or SMS.

Messaging table, FIG. 8, item 5. The web application enters the message into the message table.

Message user link table, FIG. 8, item 6. If the user creates a new thread, then the user selects the recipients from the in context user link table linked to the primary table. The user can select all linked users or a subset thereof. The user can also specify read-write or read only for the users.

Job table, FIG. 8, item 7. If the user has added email or SMS delivery, then a job is entered in the job table by the web application, with a link to the message. If not, the message is simply displayed online to other users in context.

Job executable, FIG. 8, item 8. The job executable handles the delivery of the message to the recipients.

Temp recipients table, FIG. 8, item 9. The job executable reads the job, gets the list of recipients from the message thread user link table, gets the email/SMS address from the user table, creates a mailing temporary list for the email server and sends the message to the message list on the email server using SMTP.

If the users indicated once per day delivery, then they are added to the temp recipients table and linked to the job record.

Email server, FIG. 8, item 10. The email server sends the email to the email server list account with the body of the email as the body and the list of email/SMS gateway addresses.

File server, FIG. 8, item 11. If there is an attachment to the email, the job executable adds a http download link to the body of the email linking the file to the email and stages the file on the file server, and adds a job to delete the file in 24 hours

Email server, FIG. 8, item 12. Once per day, the job executable sends out all text messages to those users who requested once per day delivery as opposed to immediate delivery

Recipient users, FIG. 8, item 13. Outbound emails and SMS messages are addressed as follows: <s_rowId of user link table to messaging meta table>@<system>.com. Most cell phones can respond to emails. If the recipient cell phone user replies to the SMS message, the receiving email server will put the email in a catch all account (since no account on the email server is setup for that address). The job executable will retrieve all inbound catch-all messages, and if they are correctly addressed as above, will insert them in the appropriate email tables as a reply to the outbound message. In this fashion, an email style discussion can be used between an email client and an SMS client.

### Meta-Functions/User Examples/Video and Non-Video File Sharing/Components

Video and non-file sharing, Table 13, item 3. This is the set of related tables which enable video and non-video file sharing throughout the system. This system enables linking of any uploaded file to any other table, and enables in context automatic linking In addition, it anticipates displaying files in multiple formats and granting users multiple levels of permissions (read-only, download, etc.).

The chief differences between the handling of video and non-video files is the display server—a web server for files and a video server for video files. FIG. 9 is an overview of the components of video and non-video file sharing.

SQL Server, FIG. 9, item 1. This is the SQL server described in FIG. 3, item 1. This is required for the operation of the system

Master file table, FIG. 9, item 2. This is the meta function master table described in FIG. 5, item 4. In the case of non-video files, there will be two files, an HTML 5 compliant version of the file and the original file. In the case of video files, there will be a series of linked video files organized by this table into a playlist. The video segments will also have an associated JPEG thumbnail. This record also records whether the original file is authorized for download (in the case of non-video files).

File segments table, FIG. 9, item 3. This is the meta function data table described in FIG. 5, item 5. This table records the location of the original file and the location of the HTML 5 display version of the file created by the job system. It also contains the encryption password used to store the file. It also contains links to thumbnails of the files. Multiple files are linked using the parent zero feature. File types are distinguished by a binary or field. For non-video files, 1 means original file, 2 means a JPEG of a single page (with a second field to order the JPEGs) and 4 means a downloadable PDF. For video files, 1 means original segment and 2 means a JPEG thumbnail of the video.

Primary link table, FIG. 9, item 4. This is the meta function primary link table described in FIG. 5, item 6. It associates files with primary table records through the web application. This record also indicates whether all users of the primary table record can see this record, or only selected users.

User link table, FIG. 9, item 5. This is the meta function user link table described in FIG. 5, item 7. This links files to users, and records read-only/read-write rights, download rights, etc.

Web application, FIG. 9, item 6. This is the web application described in FIG. 5, item 8. If a selected file is not available in the web application file cache, then the web application retrieves the file from the file server.

File sharing components, web application file cache, FIG. 9, item 7. This is the disk cache of video and non-video files maintained by the web application.

File sharing components, File server, FIG. 9, item 8. This is the source of uncached files for the web application.

File sharing components, file processing server, FIG. 9, item 9. The file processing server prepares uploaded files for presentation. Its operation is described in FIG. 10.

### Meta-Functions/User Examples/Video and Non-Video File Sharing/Operation on Uploads

SQL Server, FIG. 10, item 1. This is the SQL server described in FIG. 3, item 1. This is required for the operation of the system.

Web application, FIG. 10, item 2. The web application (1) accepts a file upload from the user together with user supplied descriptive information, (2) stores the file on the file server and (3) enters a job in the job table including the descriptive information.

File server, FIG. 10, item 3. The file server functions an FTP server and holds the uploaded files for use by the web servers and the file processing server.

FIG. 10, item 4. The file processing server produces additional files from uploaded user files, which additional files are used for presentation purposes. The file processing server contains a number of sub components.

FIG. 10, item 5. The file processing server contains a number of application programs which can read and print various file formats, including, for example, Microsoft office, WordPerfect office, open office, CAD readers, DICOM readers and a JPEG snapshot program which can extract JPEG images from video files and FLV files and can encode uploaded video files into web browser compatible formats. These programs format the incoming user files for the printer driver, or in the case of video files encode them in web compatible formats. Video files are presented in web browser compatible formats. Picture files are presented at JPEGs. Non-video, non-picture files are presented in FLV or HTMLS formats.

Conversion process, FIG. 10, item 6. The file processing server has various open-source and proprietary print and conversion drivers which can produce files in the following formats: PDF, JPEG, FLV, HTMLS and web browser compatible video formats. The file processing server also includes a JPEG extractor program for video files.

Job table, FIG. 10, item 7. The job table stores the job requests from the web application for the job executable.

Job executable, FIG. 10, item 8. The detailed operation of the job executable in this context is described in FIG. 11.

### Meta-Functions/User Examples/Video and Non-Video File Sharing/Operation of Job Executable on Uploads

SQL Server, FIG. 11, item 1. This is the SQL server described in FIG. 3, item 1. This is required for the operation of the system.

Job table, FIG. 11, item 2. The job table contains the jobs provided by the web application and the job executable in other contexts.

Job executable, FIG. 11, item 3. The job executable continually scans the job table and selects the job from the job table from the web application.

File server, FIG. 11, item 4. The job executable identifies the file to be processed, and the job executable retrieves the file from the file server.

Conversion process, FIG. 11, item 5. The job executable determines from the file extension the file type, and:
if it is a recognized non-video file, prints the document to a series of separate per page large JPEGs and small thumbnail JPEGs and a single PDF, as well as an FLV or HTMLS version for display in browsers
if it is a recognized video file, encodes the file in web browser compatible format extracts a JPEG from the beginning of the file
if is it an unrecognized file, uses a prepared default JPEG and PDF that states that the file is of an unidentified type, extracts a JPEG from the beginning of the file

File server, FIG. 11, item 6. The job executable uploads the JPEG and PDF files to the file server and deletes the local copy of the original file and the additional JPEG and PDF files.

Meta function database, FIG. 11, item 7. The job executable updates the file database for the presence of the files and includes the description obtained from the job table.

Email server, FIG. 11, item 8. The job executable sends an email and an alert to the user.

Web server, FIG. 11, item 9. The job executable updates the user through the web application by way of the job table.

### Meta-Functions/User Examples/Video and Non-Video File Sharing/Operation of Job Executable on Downloads

SQL Server, FIG. 12, item 1. This is the SQL server described in FIG. 3, item 1. This is required for the operation of the system.

Web Application, FIG. 12, item 2. The web application (FIG. 5, item 8) accepts the download request from the user and checks authority for it against the meta function user link table, FIG. 5, item 7.

Job table, FIG. 12, item 3. The web server inserts the request into the job table.

Job executable, FIG. 12, item 4. The job executable continually scans the job table and selects the job from the job table from the web application.

File server, FIG. 12, item 5. The job executable identifies the file to be processed, and the job executable retrieves the file from the file server.

Conversion process, FIG. 12, item 6. The job executable determines from the file extension the file type, and:
if the user has requested a file that is represented by a PDF, the PDF is staged on the file server for download
if the user has requested a page from a file represented by a PDF, the job executable extracts that page and stages it on the file erver for download
if the user has requested a video file or a picture file, the encoded video file or JPEG as the case may be is staged on the file server for download
if the user has requested a frame or segment from a video file, the job server stages the original video on the file server, extracts the frame or segment, and stages the frame or segment on the file server for download server

Email server, FIG. 12, item 7. The job executable sends an email with links to the staged files and an alert to the user.

Web application, FIG. 12, item 8. The job executable updates the web application via the job table.

### Meta Functions/User Examples/Video and Non-Video File Sharing/Libraries

File sharing libraries, video and non-file sharing, Table 13, item 4. Video and non-video files can be organized into libraries using the table catalog system. FIG. 13 describes video and non-video file sharing libraries.

SQL Server, FIG. 13, item 1. This is the SQL server described in FIG. 3, item 1. This is required for the operation of the system.

Master library table, FIG. 13, item 2. This is the meta function master table described in FIG. 5, item 4. This table contains descriptive information for the library collection, and acts as a grouping mechanism for component master file records. The relationship between a master library table and a master file table is similar to the relationship between a disk directory and disk files.

File segments table, FIG. 13, item 3. This is the meta function data table described in FIG. 5, item 5. This table links individual video and non-video master file table records to the master library table.

Primary link table, FIG. 13, item 4. This is the meta function primary link table described in FIG. 5, item 6. It associates file libraries with primary table records through the web application.

User link table, FIG. 13, item 5. This is the meta function user link table described in FIG. 5, item 7. This links users to the master library table, and records download rights (e.g. view only, download).

Web application, FIG. 13, item 6. This is the web application described in FIG. 5, item 8. The web application manages the user interaction with this system.

### Meta Functions/User Examples/Calendar Events

Calendar events, Table 13, item 5. Calendar events can be attached by the task system to any record in the database. The calendar system is presented by the web application on both a per user and per primary table link basis. Each user has a default calendar, and as many other calendars as the user cares to create, all associated with the user=s user record. Each other primary table, as directed by the task system, also can have calendars. When viewing the calendar attached to the user=s record, the user can see all tasks and events to which the user is linked, either directly through the user=s calendar or through primary table calendars. FIG. 14 is an overview of the calendar system.

SQL Server, FIG. 14, item 1. This is the SQL server described in FIG. 3, item 1. This is required for the operation of the system.

Master calendar events table FIG. 14, item 2. This is the meta function master table described in FIG. 5, item 4. It represents a calendar. Users and primary tables can have many calendars, so as to be able to organize events and tasks. This table acts as the organizing record for related a set of calendar records.

Calendar events item table, FIG. 14, item 3. This is the meta function data table described in FIG. 5, item 5. This record includes the data listed in Table 16. Times are stored as UTC and adjusted to the user=s zone by the web application for display.

Table 16 is a listing of the fields in the calendar events data table.

TABLE 16

| Field | Description |
|---|---|
| Start time date | These fields mark the start date time and end date time of |
| and end time | the item. |
| date | |
| Description | These fields describe the event and the locations. |
| and location | |
| Repetition | The repetition GUID is used to create repetitive events. |
| GUID | When a repetitive event is created, all of the events are |
| | created, one record for each repetition. These records are |
| | linked by the repetition GUID so the web application can |
| | offer to apply user changes to one event, or all related |
| | events, as the user decides. |
| Privacy status | The privacy status field values are: invisible (only the |
| flag | creator user can see the event/task, private (the time used |
| | by the event/task is disclosed but no details about the |
| | task) and |

Calendar events primary link table, FIG. 14, item 4. This is the meta function primary link table described in FIG. 5, item 6. This links the calendar master record to the associated primary table record.

Calendar events master user link table, FIG. 14, item 5. This is the meta function user link table described in FIG. 5, item 7. This link links users to the master calendar record. The link record indicates user status: owner, read-write, read only.

Calendar events item user link table, FIG. 14, item 6. This is the meta function item user link table described in FIG. 5, item 9. This link links users to the calendar item table. This links users who do not have access to the master calendar record, or who have been invited by the master calendar owner to join the particular item to their calendar. This records contains acceptance status (sender, accepted, rejected, optional, modification proposed).

Reminder table, FIG. 14, item 7. The reminder table holds user created reminders for events. The reminder table is a child of the calendar item use link table link. The data includes
a parent link between this table the calendar item table
time dependency fields, meaning when should the reminder be sent?

Time dependency data includes:
dependency on when the parent field starts or ends
a digit of any positive or negative value
minutes, hours, days, weeks, months
valid end day of week, all, Monday through Friday, Monday through Saturday

Also recorded is
the actual reminder time in UTC,
whether the user wants to be reminded by an onscreen alert, email and/or SMS
whether the reminder has been sent

Web application, FIG. 14, item 8. This is the meta function web application described in FIG. 5. The web application presents this meta function to the user, and maintains the consistency of the reminder system (when a user changes an event or task record, the web application updates all reminders). The web application presents data to the user in the user=s local time zone, but stores the data in UTC.

Job executable, FIG. 14, item 9. This surveys the reminder table every minute or so, and sends reminders and updates the reminders to indicate that they have been sent.

### Meta Functions/User Examples/Calendar Tasks

Calendar tasks, Table 13, item 6. Calendar tasks (meaning to do=s or projects, as opposed to the Task system described herein) can be attached by the task system to any record in the database. When viewing the user=s user record, the user can see all calendar tasks associated with that user regardless of the source primary record. When viewing any other primary record, the user can see the calendar tasks associated with that record and that user. FIG. 15 is an overview of the calendar task system.

SQL Server, FIG. 15, item 1. This is the SQL server described in FIG. 3, item 1. This is required for the operation of the system.

Calendar task item table, FIG. 15, item 2. This is the meta function data table described in FIG. 5, item 5. This record includes the data listed in Table 13 Times are stored as UTC and adjusted to the user=s zone by the web application for display.

Table 17 is a listing of the fields in the calendar task data table.

TABLE 17

| Field | Description |
|---|---|
| Start time date | These fields mark the start time and end time of the item. The system also records the |
| and end time | initial and current projected scheduled start date time and end time date in order to keep |
| date | track of on-time performance. |
| Description | These fields describe the event. |
| and location | |
| Repetition | The repetition GUID is used to create repetitive tasks. When a repetitive event or task is |
| GUID | created, all of the events-tasks are created, one record for each repetition. These records |
| | are linked by the repetition GUID so the web application can offer to apply user changes |
| | to one event or task, or all related events or tasks, as the user decides. |
| Privacy status | The privacy status field values are: invisible (only those directly connected to the task |
| flag | can see the /task, private (the time used by the /task is visible to those who can see the |
| | primary row, but no details about the task) and public, meaning the task is visible to |
| | anyone who can see the primary row. |
| Task status | This field indicates: not started, in progress, deferred, completed. |
| Task parent | This is a field id/row id reference either to a date time field in another task or a date |
| | time field in the connected primary record. A task can be made a child of another task by |
| | using this field, or can be made dependent on a date time field in a primary record. This |
| | makes use of the parent zero row feature. |
| Task parent | These fields indicates the time dependency of this task in relation to its parent primary |
| time | field, meaning when does this task start? Time dependency data includes: |
| dependency | a digit of any positive or negative value |
| | minutes, hours, days, weeks, months |
| | valid end day of week, all, Monday through Friday, Monday through Saturday |

Calendar task items are functionally similar to calendar items except as follows: (1) tasks do not expire when the end date passes—instead they have a status value (not started, deferred, in progress, completed) and expire only when marked as completed (2) tasks can be made children of other tasks using the zero parent row feature and then can have start dates that can be made dependent on the completion date of predecessor tasks.

Calendar task primary table link, FIG. 15, item 3. This is the meta function primary link table described in FIG. 5, item 6. This links the calendar task item record to the associated primary table record.

Calendar task user link table, FIG. 15, item 4. This is the meta function item user link table described in FIG. 5, item 7. This link links users to the calendar task item record. This record indicates user status, participant, observer.

Reminder table, FIG. 15, item 5. The reminder table holds user created reminders for events and tasks. The reminder table is a child of the calendar item use link table link. The data includes
a parent link between this table the calendar item table
time dependency fields, meaning when should the reminder be sent
function dependency field, meaning should a reminder be sent if the start date or end date changes, or if the task has not been completed on time.

Time dependency data includes:
dependency on when the parent field starts or ends
a digit of any positive or negative value
minutes, hours, days, weeks, months
valid end day of week, all, Monday through Friday, Monday through Saturday

Also recorded is
the actual reminder time in UTC,
whether the user wants to be reminded by an onscreen alert, email and/or SMS
whether the reminder has been sent

Web application, FIG. 15, item 6. This is the meta function web application described in FIG. 5. The web application presents this meta function to the user, and maintains the consistency of the reminder system (when a user changes an event or task record, the web application updates all reminders). The web application presents data to the user in the user=s local time zone, but stores the data in UTC.

Job executable, FIG. 14, item 7. This surveys the reminder table every minute or so, and sends reminders and updates the reminders to indicate that they have been sent. In addition, this checks the time dependencies of tasks which have not yet been started or have not been completed, and updates the start times of all child tasks.

### Meta Function System/User Examples/Address Book

Address book, table 13, item 7. The system maintains a default address link system for all users, and enables users to add to that address system. The default address link system is created continuously, by linking users together who share common primary rows. Thus, users in the same OUnit, or in a child or parent OUnit, are automatically linked by the system. Users can also add non-users to their address book. In addition, the user can add other users who are not linked by a primary table to an address book by email address. The user adds an email address to their address book and if the email address is on the system, the other user is then added to the creating user=s address book. FIG. 16 is a description of the address book system.

SQL Server, FIG. 16, item 1. This is the SQL server described in FIG. 3, item 1. This is required for the operation of the system.

User login table FIG. 16, item 2. User address information is stored in a series of related tables. The user login tables are separated for speed of execution, and contain only the user=username and password.

User table FIG. 16, item 3. The main user table contains crucial identifying formation for the operation of the system (email address, cell phone number, cell carrier, VOIP address). This has a one to one relationship with the user login table. All other address and personal identifying information is contained in separate tables.

User address tables FIG. 16, item 4. The user address tables consist of five tables that contain address information, and are all children of the user table. The five tables are postal mail addresses, email addresses, phone numbers (including cell and cell carrier), online services (Skype, AOL IM, etc.) and personal information (age, job title etc.).

User link table, FIG. 16, item 5. This is the user link table described in FIG. 5, item 7. This links users to the user record of other users, and hence to their address books, based on their independent links to the primary table.

Web application, FIG. 16, item 6. This is the meta function web application described in FIG. 5. This runs the address book user interface. As a user visits a primary table, or is added to a primary table, the web application enters a job in the job system to have the job system update the user=s links to the other user=s user records. The web application also enables users created non-user login connected user records to be able to add non-user records to the system.

Job executable, FIG. 16, item 7. The job executable updates user links as requested by the web application.

Primary table, Primary link table, FIG. 16, item 8. This is the meta function primary link table described in FIG. 5, item 6. This links the calendar master record to the associated primary table record.

### Meta Function System/User Examples/Keyword Tags

Key word tags, Table 13, item 8. The keyword tagging system enables keyword tagging of any primary record, and the ability to search records by keyword tag. FIG. 17 is a description of the keyword tagging system.

SQL Server, FIG. 17, item 1. This is the SQL server described in FIG. 3, item 1. This is required for the operation of the system.

Master keyword table, FIG. 17, item 2. This is the meta function master table described in FIG. 5, item 4, the meta function data table described in FIG. 5, item 5, meta function primary link table described in FIG. 5, item 4 and the meta function user link table described in FIG. 5, item 7. The keyword table enables a user to attach a searchable set of text key words and phrases to any record in the system. This enables the user to find any tagged record by search for the keyword.

The keyword system assumes that an individual key word record will be attached to only one primary table and one user. Thus, the keyword table incorporates the meta function tables listed in a single table. The master keyword table includes the following fields:
a table catalog system link to a primary table and row
a child field link to a user record
a unicode variable length text field that contains the key words and is indexed by the SQL engine.

This system is an example of a simplified meta function, where only single links to primary records and user records are anticipated.

SQL search engine, FIG. 17, item 3. The built-in SQL text indexing function indexes the tag field in the master keyword table for searching purposes.

Web application, FIG. 17, item 4. This is the meta function web application described in FIG. 5. The web application enables the search function.

### Meta Function System/User Examples/Approvals

Approvals, table 13, item 9. FIG. 18 is a description of the approval system. The approval system enables users to approve the state of a record. This is useful in billing and transaction oriented systems.

SQL Server, FIG. 18, item 1. This is the SQL server described in FIG. 3, item 1. This is required for the operation of the system.

Approval table, FIG. 18, item 2. This is the meta function master table described in FIG. 5, item 4, the meta function data table described in FIG. 5, item 5, meta function primary link table described in FIG. 5, item 4 and the meta function user link table described in FIG. 5, item 7. The approval system enables a user to approve the current state of a primary record, its child records and non-video file records attached to it through the meta function system. An example of the usefulness of this is when a primary record represents a purchase order. Approval is evidenced by a hash record which is the hash of a string concatenation of all the time stamp fields of the primary record and its related records. If any of those records are changed, the time stamp fields, will change, invalidating the approval.

The approval system is a simplified version of the meta function table catalog system. The approval system assumes that an individual approval record will be attached to only one primary table and one user. Thus, the approval table incorporates the meta function tables listed above in a single table. The master approval table contains the following fields:
a table catalog system link to a primary table and row
a child field link to a user record
a binary field which stores the hash of a string concatenation of all the time stamp fields in the primary record and related records.

Web application, FIG. 18, item 3. This is the meta function web application described in FIG. 5. Administrators create approval records, and link the user to the primary record. When the user approves the primary record, the web application, based on information in the task system, concatenates the time stamp fields of the primary record and all related records, calculates a hash value, and stores the hash value in the approval record. When another user wants to determine whether a user has approved a record, the inquiring user asks the web application to re-do the calculation and compare it to the approving user=s stored hash value. If the values match, the record remains approved. If not, the record is unapproved.

### Meta Function System/User Examples/Video System

Video services, table 13, item 10. The system manages the storage and display of video files. FIG. 19 is a description of the video system. FIG. 19 is a description of the video system.

SQL Server, FIG. 19, item 1. This is the SQL server described in FIG. 3, item 1. This is required for the operation of the system.

Master video table, FIG. 19, item 2. This is the meta function master table described in FIG. 5, item 4, the meta function data table described in FIG. 5, item 5, and meta function primary link table described in FIG. 5, item 4. The video table enables a user to attach a primary record to a video server. The video server provides live streaming, meaning one user (the host) streams video and audio out from their PC to the video server and other users view the video, hear the audio, and can use the text chat function in the video player in their browsers to chat with each other and the host. The video server also provides web based video conferencing, meaning each user can hear and see the other users.

The video system is a simplified version of the meta function table catalog system. The video system assumes that each record in the master video table will be attached to only one primary record. Thus, the master video table incorporates the meta function master table, the meta function primary table link table and the meta function data table in a single table. The master vide system table contains the following fields
a permanent unique GUID that identifies the stream or conference on the video server
a table catalog link to the primary record

It should be noted that a primary record can have more than one master video record, and primary record users can be attached to different primary video records to provide confidentiality. But video records themselves can be linked to only one primary record.

User link table, FIG. 19, item 3. This is the meta function user link table described in FIG. 5, item 7.

Web application, FIG. 19, item 4. This is the meta function web application described in FIG. 5. When starting a video session, the starting user indicates to the web application whether the session is a stream or a conference. The web application enters an alert in the alert system and a text message in the message system to alert the other users that a stream or conference is live.

Video server, FIG. 19, item 5. The video server creates live streams and video conferences using the GUID supplied by the web application, and determines host versus guest based on the username/password pair sent by the web application. When the host wants to start the stream from the host=s PC, the host logs in to the video server using their username/password. Other users are automatically logged in as guests. On video conferences, all users who have primary access to the supporting master video record.

Meta Function System/User Examples/Billing system

Billing, Table 13, item 11. Credit card/paypal style payments can be attached to records for access. FIG. 20 describes the billing system.

SQL Server, FIG. 20, item 1. This is the SQL server described in FIG. 3, item 1. This is required for the operation of the system.

Master billing table, FIG. 20, item 2. This is the meta function master table described in FIG. 5, item 4, the meta function data table described in FIG. 5, item 5, meta function primary link table described in FIG. 5, item 4 and the meta function user link table described in FIG. 5, item 7. A user can require payment by credit card or other common payment methods by creating and linking a master billing record to a primary table record. This records the amount to be paid, the time period for access to be permitted and a table catalog link to the primary table record. The web application will not show the child records of a primary table record with a billing record attached until payment has been made, and then, only for the time period specified.

Billing data table, FIG. 20, item 3. This is the meta function data table described in FIG. 5, item 5, and the user link table described in FIG. 5, item 7. This table records the user ID of each user who has paid for access, and the date on which that access expires.

Web application, task system, FIG. 20, item 4. This is the web application/task system, FIG. 5, item 7. When the authorized user creates a billing requirement, the web application blocks access by other users until they enter payment information, which is processed by the web application, and if successful, the web application creates a record in the billing data table permitting access for the specified period of time.

### Meta Function System/User Examples/Alert System

User alert system, table 13, item 12 Alert events applicable to the user are stored in the users record and displayed to the user when online FIG. 21 describes the alert system.

SQL Server, FIG. 21, item 1. This is the SQL server described in FIG. 3, item 1. This is required for the operation of the system.

Alert table, FIG. 21, item 2. The alert system is another variation on the typical meta function system. The alert system provides the user with real time alerts about activities of other users and the job system that affect the user, and also provides a permanent system of such alerts so that when the user logs in initially, the user can see all the alerts that occurred when the user was logged out. The user table includes a unicode variable length text field. The syntax of an alert is: <alert type>#<alert time>#<table id from table catalog>#<s_rowID from row>.

Web application, task system, FIG. 21, item 3. This is the web application/task system described in FIG. 5, item 7. Based on the task system (which indicates whether alerts should be provided for a given primary table), the user link table (which records the user=s preferences regarding alerts from that primary table), when the web application makes a change to a primary record, it determines whether an alert should be issued, and if so, puts a job request in the job table for the alert.

The web application browser Javascript executes an Ajax callback every few seconds and reads the contents of the user=s alert field. When the field changes, the web server provides the alert to the user, and prompts them to go to the primary table in question (or message table if the alert is for a message) to retrieve the alerted item.

When the authorized user creates a billing requirement, the web application blocks access by other users until they enter payment information, which is processed by the web application, and if successful, the web application creates a record in the billing data table permitting access for the specified period of time.

Job system, FIG. 21, item 4. The job system retrieves the alert job, and updates the user=s alert field by, in a single update SQL statement:
retrieve the contents of the field
prepend the new alert to the contents of the field
trim the new contents to the max length of the field as needed
update the contents of the field with the new contents.

As the field is unindexed and the update is handled in a single SQL statement, the alert system can handle a very high volume of alerts.

### Meta Function System/User Examples/Language System

Language system, Table 13, item 13. The language system translates user text to any number of different languages. FIG. 22 describes the language system.

SQL Server, FIG. 22, item 1. This is the SQL server described in FIG. 3, item 1. This is required for the operation of the system.

Language data table, FIG. 22, item 2. This is the meta function data table described in FIG. 5, item 5, and the and meta function primary link table described in FIG. 5, item 7. The language table is the source of translations from English for the table catalog system the task system, the web application and the job executable. The language system provides an automated system for tracking use of language in the system and for managing the translation process. The table fields are described in table 18.

Language data table, FIG. 22, item 3. When the view maintenance executable runs, it updates the language table for the English field and table names from the table catalog system. It then adds French, German, Spanish, Italian, Portugese, Russian, Japanese, Chines and Korean, by using English where a translation has not been made, and marking the record as not translated. The task maintenance executable does the same for the task entries.

Web application, task system, FIG. 22, item 4. This is the web application/task system, FIG. 5, item 7. When the web application needs a language element, it hashes the lower case English equivalent and retrieves the appropriate translation from the language table by searching on the hash and the table and field ID. If the language item is present, it updates the count and datetime fields. If not, it creates a new record in that language, using English as the translated text. Later, the untranslated elements (as indicated by the translation flag) can be translated.

Job executable, language system, FIG. 22, item 5. The job executable follows the same language translation procedure as does the web application.

Table 18 is a description of the field design of the language table.

TABLE 18

| Field Name | Purpose |
|---|---|
| hash | binary, MD5 hash of the lower case English text, |
| | field is indexed for searching |
| English text | variable length unicode, contains the English text |
| table ID | table catalog table ID. identifies whether the |
| | source is the table catalog or the task |
| | system. If the source is the web application, |
| | this field is 0 |
| field ID | table catalog field ID. identifies the field, |
| | 0 if embedded web application text |
| comment | text field for context comments - manually |
| | entered, used by translators |
| translation | binary, 0 not translated, 1, translated |
| flag | |
| language | two character language flag (en, fr, de, |
| | es, pt, it, ru, jp, cn, kr) |
| translated | variable length unicode, contains the translated text, |
| text | initially contains the English text pending translation |
| use count | integer, count of times retrieved |
| | (updated as part of the SQL select) |
| most recent | datetime of most recent use |
| use | (updated as part of the SQL select) |

### Task System/Overview

Interactions between the web application and users, and the job/spreadsheet system, on the one hand, and the database on the other, are handled by the task database and task language. Each feature of the task system is supported by strict conformance to the design rules laid out herein. Most tasks are hierarchical and can be modeled in SQL databases following general rules. The user web application and the job/spreadsheet system access the database only through the task system, using a single general code base that interprets the task commands in the task database. Where non-hierarchical tasks are needed, the task database contains flags and the task language contains handlers for such exceptions.

There is no user role based security built into the database, nor is there any identification of user by built-in role. There are no administrators, system administrators, standard users, etc. Instead, there are tasks that can be assigned to any user. Tasks are grouped by their nature in the administrative user interface, so that administrator tasks, faculty tasks, student tasks, medical professional tasks, medical administrator tasks, patient tasks, and supplier administrator tasks are logically grouped for assignment, but nevertheless, tasks can be mixed and matched as needed (administrators who are also students and teachers for example). Tasks are assigned by organizational unit (AOUnit@), not generally throughout the system. This means that one can be both a patient and a doctor simultaneously in different OUnits, or indeed in the same OUnit. Users are assigned tasks by administrators (that is, users with administrative tasks). User security is controlled by limiting the tasks assigned to a user.

The tasks are a combination of a hierarchical navigation path through the data in the database related to the task, menus that are presented to the user at each step, and exception processing events that occur along the path. The task system depends on these hierarchical paths through the data, and thus the requirement for extreme rigidity in table design.

The system is driven by the task master table, the task detail table, and the task language (which is stored in the task detail table) and the user/OUnit and task link tables. The organization of these tables and the syntax of the task language, are described in detail below.

In the typical task, a user is first shown a grid presentation of qualifying rows with a menu that enables adding, editing and exporting. If the user selects a row, the user is shown an edit form for that row with meta functions attached and editing commands and a and a new grid of child rows. For example, courses>>classes>>students. This would show first all the courses, then one course and all the classes, then one class and all the students and so on. Some meta functions are associated with the child row grid view (key words, for example) but most are associated with single row edit view.

### Task System/Detail

Web server, FIG. 23, item 5. The web server, a hardware server running web server software, runs the web application and provides the interface through the network hardware and software to the user.

SQL server, FIG. 23, item 6. The SQL server, a hardware server running SQL database software, runs the stores all database tables used by the system, and provides the interface to the data for the web server and the job server through the network hardware and software.

Job server, FIG. 23, item 7. The job server, a hardware server running the job executable written by the applicants, runs the all non-user-interface functions and tasks and runs the spreadsheet system and has a network connection to the web server and the SQL server.

File transfer server, FIG. 23, item 8. The file transfer server is a hardware server and run by the job server to provide import/export function for the spreadsheet system through the network to and from the user.

Core task language system, FIG. 23, item 9. The core task language system consists of the task master table, the task detail table and the task data language, which specifies the language elements to be included in the task detail table rows. The task master rows=s language is self contained within the design of the task master table, as described below.

Task master table, FIG. 23, item 10. The task master table stores all tasks and menu items, one row per task or menu item. Menu items and tasks are distinguished from each other by making tasks the last element in parent-child chain of rows in the task master table. That is, if a row in the task master table has a child row in the task master table, then it is a menu item, otherwise it is a task.

Table 19 describes the fields in the task master table.

TABLE 19

| Field | Type | Description |
|---|---|---|
| Product ID | string | The product field groups all menus and tasks by product line. This enables |
| | | different end-user products to be supported simultaneously. All menus and |
| | | tasks in a product share a common, unique ID. All web logins from each web |
| | | server that has a login screen are associated with a single product. Thus, once |
| | | the user is authenticated, the users links to OUnits for that product are searched. |
| | | If the user has no OUnit linked to that product, then the login is rejected. If the |
| Item row ID | integer | All rows in a single product are consecutively and uniquely numbered. This is |
| | | used to order the presentation of the tasks and create a means of linking parent |
| | | and child rows within the table. |
| Parent row | integer | This field either has a value of 0 or the value of a parent row = s item row id. |
| ID | | This indicates whether the row is a child of another row. A value of 0 indicates |
| | | that the row is a top level menu row. A row that has children is a sub-menu. A |
| | | row that has no children is a task. |
| Top sort | integer | If the row is a top level menu (meaning a row with a parent row ID of zero), then |
| | | this field holds an integer value which tells the web application the order to |
| | | present top level menu items. If the row isn = t a top level menu, then the field |
| | | holds a value of 99. |
| Default user | integer | This indicates which tasks should be assigned to users in an oUnit after the first |
| value | | user. The first user in an oUnit always has all tasks assigned to the user. |
| o_Unit | integer | This indicates whether a task is available to all OUnits on the system (0), the |
| | | system OUnit (1) or some other specific OUnit. This field is limited by the |
| | | product id field. |
| ID | string | A unique text identifier for each row. |
| English | string | English menu text for each row (to construct localized menus), one column per |
| titles | | required language. This is used in the language system described elsewhere. |
| English | string | English help for each row, one column per required language. This is used in |
| help | | the language system described elsewhere. |

Task detail table, FIG. 23, item 11. The task detail table holds the navigational hierarchy of screens to be displayed to the user for the task. Each screen represents a screen of information to be presented to the user. Each row within a screen represents either a field to display, a table to navigate to, a function to run or a menu to present. The screens fall into three main groups—display data and edit it, display meta functions and execute them, execute an exception. Task detail can contain an unlimited number of steps for each task, executed in a hierarchical fashion and there can be multiple branches in the hierarchies. Table 20 describes the fields in the task detail table.

TABLE 20

| Field | Type | Description |
|---|---|---|
| Task id | string | links the row in task detail to the task row in task master |
| Screen id | integer | Groups and orders individual task detail rows into steps in the task |
| Row id | integer | This is a consecutive unique ordered number for every row in every step in the |
| | | task. Enables parent child relationships across steps thereby enabling |
| | | hierarchical navigation through the steps (i.e. indicates which row in a given step |
| | | is the parent of the next step). Each row is either a field, an exception, a meta- |
| | | function list, or in the first row of each step, information related to the step in its |
| | | entirety. |
| Parent row | integer | Value is either null or the row id of the parent row in the preceding step. This |
| id | | indicates to the application how to navigate down through the rows. This always |
| | | points to a row which represents a row in the database, and is always a non-null |
| | | value |
| Row type | integer | Row type indicates the type of row. See detail below. |
| Name | string | This serves a variety of name purposes. In the first row of a step this is a generic |
| | | name for the step. Where the row refers to a database field, it is the name of the |
| | | field. It can also be a generic list of meta functions to include in this step. It can |
| | | also be the name of a grouping box (in each case, see row type). |
| Type | string | In the first row of each step, this is the common table expression (SQL |
| | | statement) that retrieves the data from the system for this step. Otherwise, it is |
| | | the field type for rows used in the step. |
| Indexed | bit | Indicates whether the field can be used to re-sort the step = s data grid |
| Hint | string | In the first row of a step, this is a SQL statement which produces a list of users |
| | | that have access to any selected row in the step. Other hints are listed below |
| English | string | This is the descriptive title that is displayed to the user. This is used in the |
| title | | language system described elsewhere. |
| English | string | This is popup help for each row. This is used in the language system described |
| help | | elsewhere. |

Table 21 describes each value of row types used within the task detail table. Row types are assigned binary values, and are parsed using binary or and binary and math.

TABLE 21

| Name | Value | Description |
|---|---|---|
| (Main row types) | | All row types include this value plus at least one child value |
| TableRow | 1 | the table row, one per step |
| FieldRow | 2 | database field row |
| FormControlRow | 4 | controls a form control (meaning not associated with a db field) |
| DisplayGroupRow | 8 | display grouping/formatting row |
| ReportRow | 16 | a report row - used by the report engine |
| ControlRow | 32 | global control row - controls add edit delete ok cancel buttons, one |
| | | per table |
| (TableRow values) | | These are additional directives re tables |
| TableLink | 64 | this is a link table |
| TableList | 128 | this is a list table |
| FunctionTask | 256 | is a function row - execute the function |
| FlagTask | 512 | is a flag row - receive admin emails, for example - no code - used |
| | | where the task itself is used for the sole purpose of assigning some |
| | | feature to a user |
| (FieldRow values) | | These are additional directives re fields |
| FieldRowID | 64 | Is the row id field |
| FieldGrid | 128 | Show in the grid |
| FieldRowShow | 256 | Show in the row form |
| FieldEdit | 512 | Edit in the row or grid form |
| FieldNotNull | 1024 | Required to be not null re user edits |
| FieldTextArea | 2048 | Is a text area field |
| FieldFileTransfer | 4096 | Is a file transfer field |
| FieldSelect | 8192 | Field should be a drop down html list |
| FieldPassword | 16384 | Field should be masked as a password |
| FieldInvisibleInEdit | 65536 | Field should not be shown in an edit form |
| (Form Controls) | | These are additional controls to the row edit form that add exception |
| | | processing. These are html controls. |
| FT_Button | 64 | Button |
| FT_CheckBox | 128 | Check box |
| FT_File | 256 | File |
| FT_Hidden | 512 | Hidden |
| FT_Image | 1024 | Image |
| FT_Password | 2048 | Password |
| FT_Radio | 4096 | Radio |
| FT_Reset | 8192 | Reset |
| FT_Select | 16384 | Select |
| FT_Link | 32768 | Hyperlink |
| (Control Row | | These determine what controls should appear on the grid, edit and |
| Directives) | | what meta features should appear. |
| ControlGrid | 64 | Indicates what directives should appear on a grid of records, one or |
| | | more of: add\|edit\|delete\|cancel\|spreadsheet |
| ControlRowEdit | 128 | Indicates what directives should appear on a row edit form, one or |
| | | more of: update\|cancel |
| ControlToolBar | 256 | Indicates what meta-functions should appear on the row edit screen, |
| | | one or more of: messaging\|video\|files\|chat\|forums\|video |
| | | conference\|voip\|calendar\|contacts\|key words\|user list\|audit |
| (Report Edit | | These determine features of the exported spreadsheet |
| Directives) | | |
| ReportEditDirective | 64 | data is one or more of: nochange\|add\|edit\|delete |

Table 22 describes hint values. There can be more than one, delimited by a pipe—the hint can be delimited by internally by /.

TABLE 22

| Name | Description |
|---|---|
| {A}<SQLStatement> | The SQL statement that will return list of users who can access a particular |
| | record using that task. This enables direct links from outside the system |
| | (e.g., a link in an email) and enables the web application to go directly to |
| | such record by first confirming that the user is allowed to see the record. |
| {L}<CastText>/<Table>/ | Link two fields together (a text field and a numeric field) for presentation in |
| <Field> | a spreadsheet. This is used to enable relational integrity in imports. |
| {M}<Table>/<Sort Order> | Used to add lookup functionality to fields without Al_@ in their names |
| {S}<FID> | Synchronize this field with the indicated FID in the current field value array |
| | when updated. FID means field ID from the view system. |
| {W}<FID> | Add this FID to the where clause (used with linking tables). |
| {GI}<Link Table>/<User | Used with general tables (that is, tables that provide meta function |
| Table> | services), indicates the associated link and user tables |
| {E}<FunctionName> | |
| | The name of the associated Event Processing Function - can be followed |
| | with a pipe delimited list of data |
| {V}<TID> | Vertical partition table - with TID (table id from the view system) of main |
| | table - so that you can navigate down from vertical partition tables |
| {O}<Order By Clause> | Order by clause to be used with CTE in the |
| {ExCm} | Spreadsheet comment to be included in column in exported spreadsheet |
| {GV}<name> | Use the value in the global variable |
| {F}<name> | Use the value returned by the named standard function |
| {SS}<statement> | Use the value returned by the SQL statement. |

Table 23 is an illustration of the task master table. In operation, the web application would construct menus starting from the user task link table and then back through the task master table. The user would be able to navigate the menus in the user=s web browser and select a task to run. Rows 3, 4, 5, 7, 8 and 9 are tasks.

TABLE 23

| | Item | | | | | | | |
|---|---|---|---|---|---|---|---|---|
| Product | row | Parent | Top | | oUnit | | | |
| ID | id | row id | Sort | Default | ID | Task id | Title | Help |
| school | 1 | 0 | 0 | 0 | 0 | school.home | Home | (help |
| | | | | | | | | text) |
| school | 2 | 1 | | 0 | 0 | school.home.- | Menu | (help |
| | | | | | | group1 | Group1 | text) |
| school | 3 | 2 | | 0 | 0 | school.home.- | Task1 | (help |
| | | | | | | group1.task1 | | text) |
| school | 4 | 2 | | 0 | 0 | school.home.- | Task2 | (help |
| | | | | | | group1.task2 | | text) |
| school | 5 | 2 | | 0 | 0 | school.home.- | Task3 | (help |
| | | | | | | group1.task3 | | text) |
| school | 6 | 0 | 1 | 0 | 0 | school.help | Help | (help |
| | | | | | | | | text) |
| school | 7 | 6 | | 0 | 0 | school.help.- | Menu | (help |
| | | | | | | group1 | Group1 | text) |
| school | 8 | 7 | | 0 | 0 | school.help.- | Task1 | (help |
| | | | | | | group1.task1 | | text) |
| school | 9 | 7 | | 0 | 0 | school.help.- | Task2 | (help |
| | | | | | | group1.task2 | | text) |

Table 24, 25 is an illustration of a related task detail table, associated with the preceding Table 23. The operation of this example is described below in the application section of this application.

TABLE 24, 25

| | | | | | | | | | | |
|---|---|---|---|---|---|---|---|---|---|---|
| school.home.- | 0 | 0 | | 1 | Summary | | | | Summary | [help] |
| group1.task1 | | | | | | | | | | |
| school.home.- | 0 | 1 | | 258 | UserDsply | nvarchar(64) | | {SS}SELECT | User | [help] |
| group1.task1 | | | | | AsName | | | TOP (1) | Name | |
| | | | | | | | | T1.DsplyAsName | | |
| | | | | | | | | FROM dbo.zUser | | |
| | | | | | | | | AS T1 WITH | | |
| | | | | | | | | (NOLOCK) | | |
| | | | | | | | | WHERE | | |
| | | | | | | | | T1.s_rowID = | | |
| | | | | | | | | @TMemUser | | |
| | | | | | | | | #eTMemUser | | |
| | | | | | | | | ID#$ | | |
| school.home.- | 0 | 2 | | 258 | OUnitDsply | nvarchar(64) | | {SS}SELECT | Organization | [help] |
| group1.task1 | | | | | AsName | | | TOP (1) | Unit | |
| | | | | | | | | T1.DsplyAsName | | |
| | | | | | | | | FROM | | |
| | | | | | | | | dbo.zOUnit | | |
| | | | | | | | | AS T1 WITH | | |
| | | | | | | | | (NOLOCK) | | |
| | | | | | | | | WHERE | | |
| | | | | | | | | EXISTS | | |
| | | | | | | | | (SELECT | | |
| | | | | | | | | TOP (1) | | |
| | | | | | | | | T2.s_rowId | | |
| | | | | | | | | FROM | | |
| | | | | | | | | dbo.zUser AS | | |
| | | | | | | | | T2 WITH | | |
| | | | | | | | | (NOLOCK) | | |
| | | | | | | | | WHERE | | |
| | | | | | | | | T2.s_rowId = | | |
| | | | | | | | | @TMemUser | | |
| | | | | | | | | #eTMemUser | | |
| | | | | | | | | ID#$ AND | | |
| | | | | | | | | T2.p_OUnit = | | |
| | | | | | | | | T1.s_rowId) | | |
| school.home.- | 0 | 3 | | 258 | RprtDate | smalldatetime | | {F}getutcdate | Report | [help] |
| group1.task1 | | | | | | | | ( ) | Date | |
| school.home.- | 0 | 4 | | 258 | ExprtnDate | smalldatetime | | {F}getutcdate | Expiration | [help] |
| group1.task1 | | | | | | | | ( ) + 7 | Date | |
| school.home.- | 0 | 5 | | 258 | TbleName | nvarchar(64) | | {GV}@Tble | Data | [help] |
| group1.task1 | | | | | | | | Name | Source | |
| school.home.- | 0 | 6 | | 258 | RprtGUID | uniqueidentifier | | {GV}@Rprt | Report | [help] |
| group1.task1 | | | | | | | | GUID | ID | |
| school.home.- | 1 | 7 | | 1 | WorkTable | WITH CTE | | “{A}SELECT | | |
| group1.task1 | | | | | | (FieldList) AS | | TOP (100) | | |
| | | | | | | (SELECT | | PERCENT | | |
| | | | | | | TOP (100) | | T1.DsplyAsName, | | |
| | | | | | | Percent | | T1.eTMemUserId | | |
| | | | | | | FieldList | | FROM | | |
| | | | | | | FROM | | dbo.zTMemUser | | |
| | | | | | | Table WITH | | T1 WITH | | |
| | | | | | | (NOLOCK) | | (NOLOCK) | | |
| | | | | | | /**WhereClause**/ | | WHERE | | |
| | | | | | | /**WhereTag**/ | | EXISTS | | |
| | | | | | | /**Excel**/)\| | | (SELECT | | |
| | | | | | | {O}T1.s_rowid | | TOP 1 | | |
| | | | | | | ASC | | T2.TMemUser_{—} | | |
| | | | | | | | | FROM | | |
| | | | | | | | | dbo.zTMemTaskLink | | |
| | | | | | | | | T2 WITH | | |
| | | | | | | | | (NOLOCK) | | |
| | | | | | | | | WHERE | | |
| | | | | | | | | T1.eTMemUserID = | | |
| | | | | | | | | T2.TMemUser_{—} | | |
| | | | | | | | | AND | | |
| | | | | | | | | T2.TCmmnTaskMID = | | |
| | | | | | | | | @TCmmnTaskM#TCmmn | | |
| | | | | | | | | TaskMID#$) | | |
| | | | | | | | | AND EXISTS | | |
| | | | | | | | | (SELECT | | |
| | | | | | | | | TOP 1 | | |
| | | | | | | | | T3.eTMemOUnitID | | |
| | | | | | | | | FROM | | |
| | | | | | | | | dbo.zTMemOUnit | | |
| | | | | | | | | T3 WITH | | |
| | | | | | | | | (NOLOCK) | | |
| | | | | | | | | WHERE | | |
| | | | | | | | | T3.eTMemOUnitID = | | |
| | | | | | | | | T1.TMemOUnit_{—} | | |
| | | | | | | | | AND EXISTS | | |
| | | | | | | | | (SELECT | | |
| | | | | | | | | TOP 1 | | |
| | | | | | | | | T4.eTMemOrgnztnID | | |
| | | | | | | | | FROM | | |
| | | | | | | | | dbo.zTMemOrgnztn | | |
| | | | | | | | | T4 WITH | | |
| | | | | | | | | (NOLOCK) | | |
| | | | | | | | | WHERE | | |
| | | | | | | | | T3.TMemOrgnztn_ = | | |
| | | | | | | | | T4.eTMemOrgnztnID | | |
| | | | | | | | | AND | | |
| | | | | | | | | T4.eTMemOrgnztnID = | | |
| | | | | | | | | @#eRcrdID# | | |
| | | | | | | | | bigint$) | | |
| | | | | | | | | OR 1 = 1)” | | |
| school.home.- | 1 | 8 | | 96 | Add\| | | | | Add\| | [help] |
| group1.task1 | | | | | Edit\| | | | | Edit\| | |
| | | | | | Delete\| | | | | Delete\| | |
| | | | | | Cancel\| | | | | Cancel\| | |
| | | | | | Excel | | | | Excel | |
| school.home.- | 1 | 9 | | 160 | Update\| | | | | Update\| | [help] |
| group1.task1 | | | | | Cancel | | | | Cancel | |
| school.home.- | 1 | 10 | | 288 | live | | | | Live | [help] |
| group1.task1 | | | | | chat\| | | | | Chat\| | |
| | | | | | email\| | | | | Email\| | |
| | | | | | text | | | | Text | |
| | | | | | messaging\| | | | | Messaging\| | |
| | | | | | video\| | | | | Video\| | |
| | | | | | files\| | | | | Files\| | |
| | | | | | calendar\| | | | | Calendar\| | |
| | | | | | contacts\| | | | | Contacts\| | |
| | | | | | discussions\| | | | | Discussions\| | |
| | | | | | approvals\| | | | | Approvals\| | |
| | | | | | key | | | | Key | |
| | | | | | words\| | | | | Words\| | |
| | | | | | users\| | | | | Users\| | |
| | | | | | audit | | | | Audit | |
| school.home.- | 1 | 11 | | 80 | editdirective\| | | | | Edit | [help] |
| group1.task1 | | | | | nochange\| | | | | Directive\| | |
| | | | | | add\| | | | | No Change\| | |
| | | | | | edit\| | | | | Add\| | |
| | | | | | delete | | | | Edit\| | |
| | | | | | | | | | Delete | |
| school.home.- | 1 | 12 | | 8 | DefaultDisplayGroup | | | | Default | [help] |
| group1.task1 | | | | | | | | | Display | |
| | | | | | | | | | Group | |
| school.home.- | 1 | 13 | | 66 | s_rowId | bigint | 1 | {L}T1.Dsply | System | [help] |
| group1.task1 | | | | | | | | AsName\|{Ex | ID | |
| | | | | | | | | Cm}Do not | | |
| | | | | | | | | change the | | |
| | | | | | | | | existing | | |
| | | | | | | | | values in this | | |
| | | | | | | | | column. In | | |
| | | | | | | | | new rows, put | | |
| | | | | | | | | in a unique | | |
| | | | | | | | | value in each | | |
| | | | | | | | | new row - | | |
| | | | | | | | | different from | | |
| | | | | | | | | the other | | |
| | | | | | | | | values in this | | |
| | | | | | | | | column. | | |
| school.home.- | 1 | 14 | | 1922 | field1 | nvarchar(64) | 1 | | Display | [help] |
| group1.task1 | | | | | | | | | As | |
| | | | | | | | | | Name | |
| school.home.- | 1 | 15 | | 898 | field2 | nvarchar(64) | 1 | | Website | [help] |
| group1.task1 | | | | | | | | | | |
| school.home.- | 1 | 16 | | 10114 | 1_lookup1 | varchar(8) | 1 | | Status | [help] |
| group1.task1 | | | | | | | | | | |
| school.home.- | 1 | 17 | | 9986 | 1_lookup2 | varchar(8) | | | Theme | [help] |
| group1.task1 | | | | | | | | | | |
| school.home.- | 2 | 18 | | 1 | WorkTable2 | WITH CTE | | {A}SELECT | Organization | [help] |
| group1.task1 | | | | | | (FieldList) | | TOP (100) | Unit | |
| | | | | | | AS (Select | | PERCENT | | |
| | | | | | | TOP (100) | | T1.DsplyAsName, | | |
| | | | | | | PERCENT | | T1.s_row | | |
| | | | | | | FieldList | | Id FROM | | |
| | | | | | | FROM | | dbo.zUser T1 | | |
| | | | | | | Table WITH | | WITH | | |
| | | | | | | (NOLOCK) | | (NOLOCK) | | |
| | | | | | | WhereClause | | WHERE | | |
| | | | | | | /**Category | | EXISTS | | |
| | | | | | | Where**/ | | (SELECT | | |
| | | | | | | /**Excel**/)\| | | TOP 1 | | |
| | | | | | | {O}T1.DsplyAsName | | T2.p_User | | |
| | | | | | | ASC | | FROM | | |
| | | | | | | | | dbo.TaskLink | | |
| | | | | | | | | T2 WITH | | |
| | | | | | | | | (NOLOCK) | | |
| | | | | | | | | WHERE | | |
| | | | | | | | | T1.s_rowId = | | |
| | | | | | | | | T2.p_TMem | | |
| | | | | | | | | User AND | | |
| | | | | | | | | T2.CmmnTaskMID = | | |
| | | | | | | | | @CmmnTask | | |
| | | | | | | | | M#TCmmnTaskMID#$) | | |
| | | | | | | | | AND EXISTS | | |
| | | | | | | | | (SELECT TOP 1 | | |
| | | | | | | | | T3.s_rowId | | |
| | | | | | | | | FROM | | |
| | | | | | | | | dbo.zOUnit | | |
| | | | | | | | | T3 WITH | | |
| | | | | | | | | (NOLOCK) | | |
| | | | | | | | | WHERE | | |
| | | | | | | | | T3.s_rowId = | | |
| | | | | | | | | T1.p_OUnit | | |
| | | | | | | | | AND EXISTS | | |
| | | | | | | | | (SELECT | | |
| | | | | | | | | TOP 1 | | |
| | | | | | | | | T4.s_rowId | | |
| | | | | | | | | FROM | | |
| | | | | | | | | dbo.zOrgnztn | | |
| | | | | | | | | T4 WITH | | |
| | | | | | | | | (NOLOCK) | | |
| | | | | | | | | WHERE | | |
| | | | | | | | | T3.p_Orgnztn = | | |
| | | | | | | | | T4.s_rowID | | |
| | | | | | | | | AND EXISTS | | |
| | | | | | | | | (SELECT | | |
| | | | | | | | | TOP 1 | | |
| | | | | | | | | T5.s_rowId | | |
| | | | | | | | | FROM | | |
| | | | | | | | | dbo.zOUnit | | |
| | | | | | | | | T5 WITH | | |
| | | | | | | | | (NOLOCK) | | |
| | | | | | | | | WHERE | | |
| | | | | | | | | T4.s_rowUId = | | |
| | | | | | | | | T5.s_rowId | | |
| | | | | | | | | AND | | |
| | | | | | | | | T5.s_rowId = | | |
| | | | | | | | | @#s_rowId#bigint$)) | | |
| | | | | | | | | OR 1 = 1) | | |
| school.home.- | 2 | 19 | | 96 | Add\| | | | | Add\| | [help] |
| group1.task1 | | | | | Edit\| | | | | Edit\| | |
| | | | | | Delete\| | | | | Delete\| | |
| | | | | | Cancel\| | | | | Cancel\| | |
| | | | | | Excel | | | | Excel | |
| school.home.- | 2 | 20 | | 160 | Update\| | | | | Update\| | [help] |
| group1.task1 | | | | | Cancel | | | | Cancel | |
| school.home.- | 2 | 21 | | 288 | live | | | | live | [help] |
| group1.task1 | | | | | chat\| | | | | chat\| | |
| | | | | | email\| | | | | email\| | |
| | | | | | text | | | | text | |
| | | | | | messaging\| | | | | messaging\| | |
| | | | | | video\| | | | | video\| | |
| | | | | | files\| | | | | files\| | |
| | | | | | calendar\| | | | | calendar\| | |
| | | | | | contacts\| | | | | contacts\| | |
| | | | | | discussions\| | | | | discussions\| | |
| | | | | | approvals\| | | | | approvals\| | |
| | | | | | key | | | | key | |
| | | | | | words\| | | | | words\| | |
| | | | | | users\| | | | | users\| | |
| | | | | | audit | | | | audit | |
| school.home.- | 2 | 22 | | 80 | editdirective\| | | | | Edit | [help] |
| group1.task1 | | | | | nochange\| | | | | Directive\| | |
| | | | | | add\| | | | | No Change\| | |
| | | | | | edit\| | | | | Add\| | |
| | | | | | delete | | | | Edit\| | |
| | | | | | | | | | Delete | |
| school.home.- | 2 | 23 | | 8 | DefaultDisplayGroup | | | | Default | [help] |
| group1.task1 | | | | | | | | | Display | |
| | | | | | | | | | Group | |
| school.home.- | 2 | 24 | | 66 | s_rowId | bigint | 1 | {L}T1.Dsply | System | [help] |
| group1.task1 | | | | | | | | AsName\|{Ex | ID | |
| | | | | | | | | Cm}Do not | | |
| | | | | | | | | change the | | |
| | | | | | | | | existing | | |
| | | | | | | | | values in this | | |
| | | | | | | | | column. In | | |
| | | | | | | | | new rows, put | | |
| | | | | | | | | in a unique | | |
| | | | | | | | | value in each | | |
| | | | | | | | | new row - | | |
| | | | | | | | | different from | | |
| | | | | | | | | the other | | |
| | | | | | | | | values in this | | |
| | | | | | | | | column. | | |
| school.home.- | 2 | 25 | 13 | 2 | p_workTable1 | nvarchar(64) | | | Display | [help] |
| group1.task1 | | | | | | | | | as | |
| | | | | | | | | | Name | |
| school.home.- | 2 | 26 | | 1922 | data | nvarchar(64) | | | Website | [help] |
| group1.task1 | | | | | | | | | | |

tid = tasked, sid = screened, rid = rowid prid = parent row id, fv = field value, i = indexed

User/OUnit (organizational units) table, FIG. 23, item 12. This consists of three tables. The first is the user table. This contains the user=s username and password, and other user specific data. The second is the organizational unit (OUnit) table. Ounits are linked to products in the task master table, and represent the organizing element in the system. The third is the many to many link table that joins users to ° Units. Users can be linked to one or more OUnits, and OUnits can be linked to one or more users. All users of the system are controlled by this system. Ounits use the self-referencing parent feature, enabling organizations to be created from a hierarchical set of OUnits. The link table, OUnit to user, is the parent of all hieararchical tasks.

The system is presented to end users as a hierarchical chain of OUnits. It is required that all users be associated with at least one OUnit. New users who are being added by other users are added to adding user=s OUnit, or a child OUnit thereof. The system provides tasks to assign and re-assign users to new organization/OUnit chains because of errors or transfers/departures, etc. Users can be linked to as many OUnits as needed. Because tasks are assigned to user links, the users may have in effect different roles in different OUnits.

Users are identified on the system by their email addresses. Email addresses must be unique (that is, only used once in connection with a user account). This requirement of uniqueness and links to only one OUnit is for security purposes—users can be cut off from information in one organization by disabling their login.

Task link table, FIG. 23, item 13. The task link table links tasks to user-OUnit user link records. That is, tasks are linked to a user per OUnit, so a user who is a member of more than one OUnit can have separate tasks for each OUnit. The OUnit-user link table is the master table for all tasks.

### Task System/Detail/Web Application System

Web application system, FIG. 23, item 14. Table 26 is a description of the four uniform SQL functions used by the web application and the job system. This system consists of four functions, execute, insert, update and select. These functions are used in all executables that interact with the SQL databases. Uniform SQL functions achieve complete uniformity in interacting with the database among developers and applications. All SQL is identical and reflects best practices (use of proper lock hints, for example). Views are properly used and auditing is automatically carried out. Vendor independence is achieved—the application interacts with the database in the same manner regardless of the which database is in use. The entire application could be moved from Microsoft to Oracle without a single line of code change in the application itself (although the inner workings of the four functions would have to be changed to reflect operational differences among the vendor=s products).

Table 26 is a description of the four uniform SQL functions.

TABLE 26

| | |
|---|---|
| Item | Description |

Execute

| | |
|---|---|
| Purpose | Executes executes SQL statements prepared by the insert and update functions, as well as |
| | incidental direct statements prepared by application. |
| | correctly formats and parameterizes SQL statements, |
| | parameterizes them. |
| | adds comments to the SQL statement indicating the originating program, for debugging. |
| Inputs | database name (to connect to), |
| | SQL statement (as prepared by the calling function), |
| | parameter list (list of parameters contained in the SQL statement), |
| | parameter values (the values associated with the parameters) |
| Outputs | alternatively, row id (the id of the affected row), or row count (the number of rows affected) |
| | as specified by the calling function. |
| Pseudo | check syntactical validity of parameters, |
| code | check format of the SQL statement (e.g., double up single quotes), |
| | check format of parameters, |
| | check format of parameter values using the database catalog database (described elsewhere |
| | herein), |
| | format SQL for parameterization, |
| | connect to the database and execute SQL, |
| | trap errors, |
| | return requested values |

Insert

| | |
|---|---|
| Purpose | Inserts a row of data, and includes auditing. Inserts are always performed into t_views of |
| | the underlying tables, and always into the current base table, not into any partitioned |
| | versions of the base table. |
| Inputs | database name (to connect to), |
| | table name, |
| | field list, |
| | data list, |
| | row id of user issuing insert |
| Outputs | the row id of the newly created row |
| Pseudo | check syntactical validity of parameters, |
| Code | check validity of data items against both SQL syntax and against the field types of the table |
| | (using the database catalog database described elsewhere) |
| | check format of SQL (e.g., double up single quotes), format SQL for parameterization, |
| | format a correct SQL statement |
| | call the execute function with a flag to skip redundant validation checks |
| | return the row id of the new row (or a trapped error message if one is returned) |
| | prepares and executes a new parent child audit record - one row for the row id in the parent |
| | audit record, and one row for each field value in the child audit record |

Update

| | |
|---|---|
| Purpose | Updates existing rows |
| | ensures the correct partitioned table is used, |
| | limits updates to only the fields that have changes, |
| | enforces optimistic locking using the time stamp field |
| | includes auditing. |
| Inputs | database name (to connect to), |
| | table name, |
| | field list, |
| | data list, |
| | row id of row to update |
| Outputs | row count of rows affected (either 1 or 0) |

Pseudo

| | |
|---|---|
| Code | check syntactical validity of parameters, |
| | changes database to the main view database unless specific fields or conditions are present |
| | check validity of data items against both SQL syntax and against the field types of the table |
| | (using the database catalog database described elsewhere) |
| | check format of SQL (e.g., double up single quotes), format SQL for parameterization, |
| | retrieves the data in the existing row and the row = s time stamp using zview to ensure |
| | relational integrity |
| | omits from the proposed update any data which matches the existing row = s data |
| | format a correct SQL statement with both the row id and the time stamp fields as the where |
| | clause |
| | call the execute function with a flag to skip redundant validation checks |
| | return the row id of the new row (or a trapped error message if one is returned) |
| | if the time stamp value is the reason for the error, restarts the update process in a three try |
| | sequence (i.e., some other process updated the row before this process could) |
| | prepares and executes through the execute function a new parent child audit record - one |
| | row for the row id in the parent audit record, and one row for each field value in the child |
| | audit record |

Select

| | |
|---|---|
| Purpose | Gets data from tables |
| | correctly formats and parameterizes SQL statements, |
| | parameterizes them. |
| | adds comments to the SQL statement indicating the originating program, for debugging. |
| | generally retrieves data from the zviews to preserve relational integrity |
| Inputs | data format for returned data (delimited string, array, record set) |
| | database name (to connect to), |
| | SQL statement, |
| | parameter list |
| | parameter value list |
| Outputs | selected data in the form requested |
| Pseudo | check syntactical validity of parameters, |
| Code | check format of the SQL statement (e.g., double up single quotes), |
| | check format of parameters, |
| | check format of parameter values using the database catalog database (described elsewhere |
| | herein), |
| | format SQL for parameterization, |
| | connect to the database and execute SQL, |
| | trap errors, |
| | return requested values |

The task system interacts with an AJAX driven web application which directs the web servers in the creation of the web user interface, the interactions with the database, and exception functions. In this implementation, a Microsoft dot.net application executing in the web server space, but it can be implemented in any web server language.

The application uses the task database to direct all user activities. Because most user activities are in the form of either
select dataset, select item, edit/add, return (or select dataset, select item and child dataset, select child item and child dataset, etc.)
select dataset, select item, use meta-function.

Nearly all of the code of the application is reusable code that does not need to be changed as features of the system are added and changed.

Table 27 describes the login through the menu process and task selection executed by the application system.

TABLE 27
User Login Process

locate user in login database and confirm the validity of
the username and password
locates the user OUnit either from data provided by the web page
login form or by presenting the user with all of the user = s
OUnits and asking the user to select one
obtains a list of all tasks assigned to the user from the user/OUnit link
table
iterates up through the task master table for each task id to find the
chain of menus to the top level menus
that contain all of the user = s tasks
present the user = s menu
execute the user = s menu selection by execution of the task id
selected by the user for which the detail is
stored in the task detail table

Based on the example of the task master and detail tables in the preceding section, Table 28 describes the process of the application once the illustrated task has been selected. In this operative example, the user has selected row 3 from the task master table.

Table 28 is a description of the process of executing a user=s selected task.

TABLE 28
Task execution process

The screens are processed in screen id order, and within a screen, row id order. Screen zero is the first
spreadsheet in a data export request, and is not used by the web application.
The web application looks to the task detail table, locates those rows that are associated with the selected
task, and selects all the rows with a value of 1 in the screen id column
Screen one = s data is retrieved using the common table expression stored in the first row of the screen one
group in the type column.
The common table expression has a number of substitutable comments, tags and parameters that the
application replaces and populates using elements in the lower rows of the screen group and global
variables.
The rows in screen one are processed in row id order, constructing the elements of the grid view including
the meta function elements (if any).
Having executed the common table expression, and constructed the elements of the first grid view
including the data, the add/edit/delete directives, and any grid related meta-functions, the first grid is
displayed. All screens show the parent row data in an edit box or view box (as directed by the task detail
table), with a grid underneath of all child rows. If there are multiple children branches, then multiple
branches are shown below. As screen one always starts with the user, screen one shows the user = s user
data in the edit box at the top of the screen.
The user can progress down to screen two by clicking on a data row in the grid view of screen one. The
selected row in Screen one becomes the parent edit box in screen two, ad infinitum. The application
constructs the where clause of the common table expression for screen two in row 18 by determining the
child linking row in screen two from the parent row id column (as indicated in row 25), and using that in
the where clause of screen two = s common table expression. The common table expression in the example
in the first row of screen two (in the type column) is the standard common table expression for the system
in general.

By parsing the task master and detail tables, the application automatically:
determines user menu choices
presents a hierarchical route through the database
which fields are presented in grid views (a reduced set used for sorting and locating individual rows)
which fields are presented in single row edit views
the appearance of meta user functions such as email, chat, file upload with each row displayed for edit
exception function calls at each step as needed
language translations for text
export/import of hierarchical data to spreadsheets for offline manipulation.

### Task System/Detail/Job System

Job system, FIG. 23, item 15. The job system implements the task system for non-user interface operations using the job server.

The job system consists of the following:
the task system
executables written to perform a job
the job status field, the time stamp field, and the row time field of every table
the job management table where other jobs can be entered that don=t fit programmatically into existing tables
the SQL functions described above

Jobs are tasks carried out without direct user interaction (behind the scenes from the user). Jobs are carried out by executables written specifically for each job. Because every table has the required job fields, jobs can be performed against any table, and can be added at any time, and can be run retroactively. The job status field contains a binary/and/or integer value, enabling multiple jobs against the table. Jobs are executed by separate executables, not stored procedures, to reduce the load on the CPU of the SQL servers and to make it possible to increase the number of job servers without having to increase the number of SQL servers.

Jobs are initiated in one of three ways:

each executable polls the source tables for new rows, and when an executable finds a new row, it updates the job status field (using the time stamp field as a locking mechanism) to lock the row and then processes the job.

In cases where many executables are polling the same table (usually because it is a high volume table such as email), then a single polling executable is run against the table, and it inserts rows in the job management table flagging the new rows in the source table, and the job executables poll the temporary table. the web application and import job executables can also add jobs to the job management table directly, the most common example being spreadsheet imports and exports.

When jobs (including jobs started by polling for files) need to be mediated between many scaled job servers and job executables then a contention system is used to mediate among competing job executables. The job table contains a status field, which indicates whether the job needs to be performed and a time stamp field which is unique system wide. The job executables competing for a job execute the following SQL statements:
select the row id field and the time stamp field of the oldest (as to time) job that is available in the table (that is, a row with a job status of 0)
update the job status field to 1 with a where clause that specifies the row ID, the time stamp value and the job status value of 0
examine the rows affected returned by the SQL system—if the value is 1, then that job executable got the job. Job rows which have job status fields that have not been updated to two within twenty four hours are reset to zero on the assumption that the job executable failed and needs to be retried.

An example of a job is the email job system, which consists of an immediate job and a daily job. The immediate job is executed every five seconds:
the job executable selects all email records with a job status of not 1 and a row time within 72 hours of the current time
the job executable processes each email in the record set individually as follows
it updates the email record job status to a binary/and/or value of 1, using a where clause that includes the time stamp
if the rows affected count equals zero, then the job executable did not get control of the record (another instance of the same job executable did) and the process terminates
if the job executable does get control of the row, then the email process is executed then the recipients are linked to the email and the email is sent

The daily job is executed once per 24 hours, and executes identically to the immediate job, except the job status is not 2 and the job executes once every 24 hours.

Some jobs are entered by the web application directly in the job management table—spreadsheet export being a prime example. The locking process and execution process by the job executable is the same as above.

### Task System/Detail/Spreadsheet System

Spreadsheet system, FIG. 23, item 16. The spreadsheet system is the system by which data is imported and exported from the system using, in this embodiment, Excel spreadsheets.

The spreadsheet is the lingua franca of communication in the enterprise world. The task system organizes tasks and data such that the great majority of the data can easily be exported to and imported from properly designed spreadsheets. This does require that the design of the inner workings of the database anticipate this interface. This discipline is lacking in the vast majority of commercially developed databases.

Because of the task system=s rigid and predictable hierarchical flow, data in the system can be transferred to spreadsheets, including lookup data, for offline processing by end users. The data=s structure is coherently preserved in the spreadsheets using linked cross references in the spreadsheets to maintain parent-child relationships. No live connection to the database is needed. The spreadsheets can be edited offline, and submitted to the spreadsheet processing system so as to update the database data to reflect changes made in the spreadsheets. This provides greatly improved data input/edit speed over web-based user interfaces. This is part and parcel of the task system—at each level of a task, data at that level and below can be exported to a spreadsheet, together with sheets containing related lookups and parent-child relationship fields.

The spreadsheet processor application uses the same techniques as the user application to export data to spreadsheets for offline adding/editing/deleting by users, and then re-import the user=s edited spreadsheets. However, unlike simplistic table exports, the spreadsheet processor uses the task system to:
formats a complete and internally consistent spreadsheet workbook of the data, including lookup tables and cross-referenced pull downs tying data columns to related data columns (parent child)
delivers the workbook to the user through email and the Web interface
processes the user=s changes upon return of the workbook
manages security through the process

The spreadsheet system consists of:
the web application/task/meta function system, which enables the user to make a spreadsheet export
the spreadsheet master table
temporary tables which hold the data for the exported spreadsheet.

Table 29 describes the export/download process.

TABLE 29
Spreadsheet Export/Download Process

The user uses the web application and task system to navigate to the desired data grid, and selects export
The web application enters a job request in the job table in the database, recording the request and the
relevant parameters (user id, task, screen id, parent row id)
The job application processes the job
create an entry in the spreadsheet master table recording the elements of screen zero
create a temporary table in the temporary database holding the data for each screen in the task detail table
starting with the screen the user is viewing and working up the screen IDs from there
creates temporary lookup tables for all lookup data
construct an Excel style spreadsheet using the Excel object using screen zero as sheet one and a sheet for
each temporary table created above
store the spreadsheets in user accessible temporary download storage area
update the database so that the web application can direct the user to the spreadsheet for download
update the database so that the web application can direct the user to the spreadsheet for download

Table 30 describes the upload/import process.

TABLE 30
Spreadsheet upload/import process

The user uses the web application upload the user = s now edited spreadsheet
The web application enters a job request in the job table in the database, recording the upload requesting
processing
The job application processes the job
retrieves screen zero (sheet 1) from the spreadsheet and matches it to a previous job request - and ensures
that the spreadsheet has not already been processed and the spreadsheet is not too old (determined by
administrative policy)
matches edits and deletes to the rows in the temporary tables by row Id (to eliminate the possibility of
editing rows in the permanent databases that were not originally distributed in the downloaded
spreadsheet) and makes those edits in temporary tables. To avoid unintentional and intentional corruption
of data, the spreadsheet data is used to change only the temporary data (thereby ensuring that the user can
change only data that was delivered to them in the spreadsheet) and then the valid changes are made to
main data tables by the job processor.
inserts the add rows in the permanent tables (to obtain their permanent row id), adds the rows with the
spreadsheet data in the temporary tables, and updates parent child relationships in the temporary tables
with the permanent row IDs
edits the edited rows in the permanent databases with the data from the adds and edits in the temporary
databases (as per above the add rows were added so now they are just edits)
marks the deleted rows in the permanent databases as deleted
updates the job request table to indicate for the user = s benefit that the spreadsheet has been processed

### Additional Embodiments

A variety of systems can be created following this description. This system is not limited to particular hardware, operating systems or application software or hardware of any particular vendor or particular names in the naming conventions, so long as the general principles in the specific embodiments described herein.

While the foregoing description of the system enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### CONCLUSION, RAMIFICATIONS AND SCOPE

### Overview

The system is designed to run on standard hardware and generalized server software, giving the system considerable scope and scalability and low cost.

The system is a new integrated approached to improve the complex process of designing, implementing, and improving web driven database applications.
The naming and view systems are the building blocks on which the system stands, and enables automation of changes and development
The task stops the tendency towards complexity and chaos by tying the web application, the database design, and associated applications through a jointly shared system of data driven application language uses
The meta system provides global functionality to the entire system automatically as the system adds and changes features and designs
The application, function, job and spreadsheet systems provide uniformity, scalability and external connections.

The entire system provides a uniformability to create, manage, improve and scale with the greatest coding efficiency, and provide continuous improvement and benefits to end users.

The embodiment of the system described herein has the advantages described in Table 31:

TABLE 31
data driven design and data driven application from a central database
of design elements which provides a central point of reference for all
applications developed in any language
executables (software) to automate the maintenance and improvement
of the system
scalability, including automated partitioning
data driven task model for user interaction
the ability to add global meta-functions to any table and record in the
database including a complete audit function
complete coherent export/import for disconnected data formats such as
spreadsheets based on the same centralized database of design elements,
providing a tight coupling between the user and the export/import
functions
vendor independence

### Naming Conventions

The purpose of strict structural rules regarding fields, tables, and databases is to enable the automation of the entire database/web/job interface into a data driven application, and the automation of structural revisions and updates. It enables code reusability in the web/job application and eliminates nearly all hand coding once the initial system is coded and exception handling is coded. The names of the objects themselves tell the code how to handle the object. This system makes it possible to automatically scale the system through horizontal and vertical partitioning without recoding any application or job executable, distinguishes vendor/system objects from user objects for automated view construction and provides self-documentation. Elements of the system take advantage of these requirements as described below.

Mandatory fields enable code reuse. Joins and foreign keys are the same throughout the system. Specific commonly occurring field types can be coded in advance and the code reused throughout the various applications.

Unique system wide table names enable the complete disconnection between the physical structure of the database files and the applications. This is enabled by the use of a single view database that contains views of all tables, and is automatically maintained by the maintenance executable. The applications have a single connection string to a single database (the view database) that never changes, regardless of changes to the physical database files. This completely separates the physical layout among database servers from the applications. Consistent naming rules of major classes of tables, one time code, automated development and automated maintenance becomes possible. Horizontal partitioning is handled in a rapid, scalable and understandable manner that is both vendor independent and invisible to the users of the system.

The database naming conventions enable
the view system to distinguish vendor system tables from this systems tables enabling automated view construction
provides self documentation
enables horizontal scaling without recoding.

### View System

Use of a single view database and system-wide unique table names provides numerous benefits:
the underlying physical distribution of databases among servers in a server farm can be changed without any effect at all on applications using the system
databases can be added, removed, moved, tables can be moved and partitioned, in each case without changing a single line of application code
databases can be moved to new and different hardware without any changes to application
there is always a single connection string which never changes
simplicity is improved, application development time is reduced, and scalability increased. Tables and database distribution can follow two considerations: intellectual logic (self-documentation) and scalability—read only on the one hand and high transaction volume table isolation on the other
changes in demand—higher transaction volumes for example—can be addressed by modifying table and database structure without any change in the application code
the use of locking hints (such as no lock) are enforced by centralized views, improving execution speed and ensuring that proper practices are used by all application developers.
The table construction executable and spreadsheet enable the rapid construction of databases that conform to this overall design, including naming conventions.

The advantages of the no deletion—r_rowStatus—zview system are:
self documentation in each table that has a parent,
no reliance on vendor foreign key enforcement engines
speed—deletions do not have to be cascaded
speed of development—foreign key relationships can be created and deleted by adding and removing p_fields and running the view executable again
automation—automated view designers can immediately modify the standard views for changes
deleted records can be immediately un-deleted

The parent zero row feature creates the ability to have optionally enforced self-referencing parent relationships (that is, one row in a table can be a parent of another row in the same table and parent child relationships can be added and removed at will, simply by either using parent row zero (which means no parent) or a parent row s_rowID of a value other than zero. This allows for rapid design adjustment without re-coding.

### Meta Function System

The meta function system is made possible by the view system, the naming system, table catalogs and task system. The meta function system enables the addition of system-wide, in-context features as set forth in the examples without any re-coding of applications, and only the addition of independent database tables to support the meta-function data. This system provides extraordinary flexibility and ease of development of add on features.

### Task System

The task system solves a crucial problem in complex web accessed database development: how to prevent bad practices, chaotic development, and disintegration of unified programming and database design. Since the task system is the only communication point for the database and the web application, the task system enforces continued coherence between the two. In combination with the other system features: the view system the naming system, the task system enforces coherent development permanently.

The task based model provides enormous flexibility in development and design. It also enables rapid evolution of the application and the data. The entire system can be reconFigured by making changes to the task database. New tasks and new products can be added by making changes to the task database.

This task based model avoids a crucial error of most database applications: it separates the data model from the security model. The data resides where, and is organized, as it should be, as data. Security comes from assigning tasks to users. The result is that changes to the security model as embodied in the task system have no effect on the data. And users can effect many security roles (student, teacher, administrator) simultaneously in different contexts. A user can be teacher in one class and a student in another. A user can be a doctor in one matter and a patient in another.

The typical web application requires the use of hundreds of web pages that act as individual small programs in presenting database information. As web sites and databases get more complicated, the difficulty in changing, improving and altering the overall design increases dramatically. To make matters worse the nature of database design is different from the nature of web design and the changes in the two repositories of programming information deviate from each other over time. The Task/Spreadsheet system addresses all of these shortcoming, by acting as the single central translation point through which the Web application and the database must pass. All changes to tasks are instantly reflected in the web application, simply be executing the new tasks.

The very nature of a database drive application generator compels a uniform user interface to be used. This is in contrast to the difficulties of enforcing such an interface across hundreds of individual web pages created by the typical development methodology.

The code in a database driven application comes from a single source, making development and revision much easier.

Task System/Application system

By relying on the other systems, the application system becomes a extensible, scalable, fast executing user interface. All code is based on the task system and except where the task system itself requires exception handling, is reusable. Additions, extensions and modifications can be made to the user interface by changing the task system, without affecting a single line of application code.

### Task System/Job System

The job system has the following benefits:
lower CPU loads on SQL servers—the server do not execute the job, they merely provide data to the job servers
scalability—job executables can be added to as many job servers as required
flexibility—jobs can be added to any table, at any time, retroactively if need be
uniformity—jobs use the SQL functions and therefore interact with the system uniformly
tie into task system—jobs can be included in the task system

### Task System/Spreadsheet System

The spreadsheet system benefits are:
much faster clerical data entry and editing by using off-line spreadsheets
universal method for importing and exporting large amounts of data in a standardized format
unlike simplistic screen shot style export systems, relational integrity is maintained, and system lookups are usable
use of temporary tables to check incoming data prevents errors.

We claim:

1. A method of operating a plurality of servers, databases, software applications, software executables, web browsers and digital files comprising:
a. operating a plurality of computer servers;
b. maintaining naming conventions for all database objects for said computer servers;
c. maintaining standardized database views of all database tables in the system; and
d. maintaining a standardized catalog of all database objects in the system.

2. The method of claim 1, further comprising:
a. creating standardized database views of all database tables in the system; and
b. creating a standardized catalog of all database objects in the system.

3. The method of claim, wherein the method uses SQL.

4. The method of claim 1, further comprising encrypting primary identity database table fields against decryption.

5. The method of claim 1, further comprising creating and maintaining horizontally, vertically and distributed databases and database tables into a single system of SQL views.

6. The method of claim 1, further comprising tracking deleted database rows in such views through status markers.

7. The method of claim 1 wherein all of said maintaining occurs automatically.

8. The method of claim 1, further comprising tracking all or substantially all inserts, updates and deletions.

9. The method of claim 1, further comprising storing user interface elements and executable code related to said user interface elements in a database.

10. The method of claim 1, further comprising exporting and importing all data in the database in standardized spreadsheet formats and incorporating user changes made to the data in the spreadsheets automatically back into the originating database tables.

11. An apparatus for the purpose of operating a plurality of servers, databases, software applications, software executables, web browsers and digital files comprising:
a. a means of operating a plurality of computer servers;
b. a means of maintaining naming conventions for all database objects for said computer servers;
c. a means of maintaining standardized database views of all database tables in the system; and
d. a means of maintaining a standardized catalog of all database objects in the system.

12. The apparatus of claim 1, further comprising:
a. a means of creating standardized database views of all database tables in the system; and
b. a means of creating a standardized catalog of all database objects in the system.

13. The apparatus of claim, wherein the method uses SQL.

14. The apparatus of claim 1, further comprising a means of encrypting primary identity database table fields against decryption.

15. The apparatus of claim 1, further comprising a means of creating and maintaining horizontally, vertically and distributed databases and database tables into a single system of SQL views.

16. The apparatus of claim 1, further comprising a means of tracking deleted database rows in such views through status markers.

17. The apparatus of claim 1 wherein all of said maintaining occurs automatically.

18. The apparatus of claim 1, further comprising a means of tracking all or substantially all inserts, updates and deletions.

19. The apparatus of claim 1, further comprising a means of storing user interface elements and executable code related to said user interface elements in a database.

20. The apparatus of claim 1, further comprising a means of exporting and importing all data in the database in standardized spreadsheet formats and a means of incorporating user changes made to the data in the spreadsheets automatically back into the originating database tables.
